(19) United States
(12) Patent Application Publication
(10) Pub. No.: US 2022/0108051 A1
(43) Pub. Date: Apr. 7, 2022

(54) SYSTEMS AND METHODS FOR MODELING PERFORMANCE IN A PART MANUFACTURED USING AN ADDITIVE MANUFACTURING PROCESS

(71) Applicant: Sentient Science Corporation, Buffalo, NY (US)

(72) Inventors: Ziye Liu, West Lafayette, IN (US); Jingfu Liu, Prior Lake, MN (US); Behrooz Jalalahmadi, Long Island City, NY (US)

(21) Appl. No.: 17/450,042

(22) Filed: Oct. 5, 2021

Related U.S. Application Data
(60) Provisional application No. 63/088,118, filed on Oct. 6, 2020.
(60) Provisional application No. 63/112,876, filed on Nov. 12, 2020.
(60) Provisional application No. 63/199,753, filed on Jan. 22, 2021.

(51) Int. Cl. G06F 30/20; B22F 10/28; B33Y 50/02

(52) U.S. Cl. CPC G06F 30/20; G06F 2113/10; B33Y 50/02; B22F 10/28

(57) ABSTRACT

A method for modeling performance in a part manufactured using an additive manufacturing (AM) process may include obtaining geometric parameters, material parameters, AM parameters, or loading parameters. The method may include generating a process model based on the geometric parameters, the material parameters, and the AM parameters. The method may include generating a microstructure model based on the material parameters and the AM parameters. The method may include generating a performance model based on the loading parameters. The method may include performing performance simulation, including running the process model to produce a simulated part or a surface roughness mapping, running the microstructure model to produce a simulated grain structure or a simulated porosity profile of the simulated part, and running the performance model to determine a simulated performance life based on the simulated grain structure, the simulated porosity profile, or the surface roughness mapping.

### CROSS-REFERENCES TO RELATED APPLICATIONS

This application claims priority to U.S. Provisional Patent Application No. 63/088,118, entitled “DC-AM,” which was filed on Oct. 6, 2020, and is pending. This application also claims priority to U.S. Provisional Patent Application No. 63/112,876, entitled “System and Method for Predictive Modeling for Material Microstructure and Mechanical Performance of Additive Manufacturing Parts,” which was filed on Nov. 12, 2020, and is pending. This application also claims priority to U.S. Provisional Patent Application No. 63/199,753, entitled “Systems and Methods for Modeling Performance in a Part Manufactured Using an Additive Manufacturing Process,” which was filed on Jan. 22, 2021, and is pending. The entirety of these applications are hereby incorporated by reference.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### TECHNICAL FIELD

The present disclosure generally relates to additive manufacturing, and more particularly to systems and methods for modeling performance in a part manufactured using an additive manufacturing process.

### BACKGROUND OF THE DISCLOSURE

Metal additive manufacturing (AM) is becoming increasingly popular due to the significant advantages it offers. Some of these advantages include rapid prototyping, fabrication of complex geometries, reduction of product development cycles, and high utilization of material. Metal AM allows manufacturers in the aerospace industry, the defense industry, and other industries to build light-weight structures with innovative designs. However, a major barrier to metal AM is the slow and expensive qualification process for AM-produced components.

The current conventional qualification process for AM-produced components relies heavily on empirical testing, i.e., additively manufacturing the component and physically testing it. Fully qualifying an AM-produced component often requires thousands of individual tests, each of which require additively manufacturing a copy of the component. Additively manufacturing all of these copies often costs millions of dollars, and testing all of the copies may take many years to complete. A minor change of any attribute or feature of the component requires complete re-qualification.

Software-based qualification procedures can reduce qualification costs and time. Current conventional AM qualification software on the market is typically limited to thermo-mechanical analysis to predict part-level distortion. Such software can reduce development costs and time to a certain level, but it cannot assess resulting microstructure nor mechanical and dynamic properties, such as porosity, surface roughness, or fatigue life. Assessing such microstructure and properties physically consumes large amount of qualification effort.

What is needed then are systems and methods for modeling performance in a part manufactured using an additive manufacturing process.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the disclosure includes a method. The method may include a method for modeling performance in a part manufactured using an additive manufacturing (AM) process. The method may include obtaining geometric parameters or material parameters for a part, AM parameters for an AM process, or loading parameters for the part. The method may include generating a process model based on the geometric parameters, the material parameters, or the AM parameters. The method may include generating a microstructure model based on the material parameters or the AM parameters. The method may include generating a performance model based on the loading parameters.

The method may include performing performance simulation. Performing the performance simulation may include running the process model to produce a simulated part. Performing the performance simulation may include running the microstructure model to produce a simulated grain structure or a simulated porosity profile for the simulated grain structure of the simulated part. Performing the performance simulation may include running the performance model to determine a simulated performance life based on the simulated grain structure or the simulated porosity profile.

Another aspect of the disclosure is a method. The method may include a method for modeling performance in a part manufactured using an AM process. The method may include obtaining geometric parameters or material parameters for a part, AM parameters for an AM process, or loading parameters for the part. The method may include generating a process model based on the geometric parameters, the material parameters, or the AM parameters. The method may include generating a microstructure model based on the material parameters or the AM parameters. The method may include generating a performance model based on the loading parameters.

The method may include performing performance simulation. Performing performance simulation may include running the process model to produce a simulated part, a simulated temperature history for the simulated part, or a surface roughness mapping for the simulated part. Performing performance simulation may include running the microstructure model to produce a simulated grain structure of the simulated part based on the simulated temperature history. Performing performance simulation may include running the performance model to determine a simulated performance life based on the simulated grain structure, the surface roughness mapping for the simulated part, or the loading parameters.

Numerous other objects, advantages and features of the present disclosure will be readily apparent to those of skill in the art upon a review of the following drawings and description of various embodiments.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic part diagram illustrating one embodiment of a system for modeling performance in a part manufactured using an additive manufacturing (AM) process.

FIG. 2A is a flowchart diagram illustrating one embodiment of a method for modeling performance in a part manufactured using an AM process.

FIG. 2B is a flowchart diagram illustrating one embodiment of a method for modeling performance in a part manufactured using an AM process.

FIG. 3 is a flowchart diagram illustrating one embodiment of a method for modeling performance in a part manufactured using an AM process.

FIG. 4 is a perspective view illustrating one embodiment of a portion of a simulated part during the step of running a process model.

FIG. 5A is a graph illustrating one embodiment of a simulated temperature history of a point on the portion of the simulated part of FIG. 4

FIG. 5B is a table illustrating one embodiment of the simulated temperature history of the graph of FIG. 5A.

FIG. 6 is a cutaway side view illustrating one embodiment of residual stress profile of a simulated part during the step of running a process model.

FIG. 7 is a cutaway side view of illustrating embodiment of a distortion profile of a simulated part during the step of running a process model.

FIG. 8A is a perspective view illustrating one embodiment of a portion of a simulated part during the step of running the microstructure model.

FIG. 8B is a cutaway size view illustrating one embodiment of a portion of a simulated part during the step of running the microstructure model.

FIG. 8C is a cutaway size view illustrating one embodiment of a portion of a simulated part during the step of running the microstructure model.

FIG. 8D is a cutaway size view illustrating one embodiment of a portion of a simulated part during the step of running the microstructure model.

FIG. 9 is a schematic diagram illustrating one embodiment of a portion of a database for modeling performance in a part manufactured using an AM process.

FIG. 10 is a cutaway side view illustrating one embodiment of a portion of a simulated part during the step of running the microstructure model showing multiple porosity zones.

FIG. 11 is a flowchart diagram illustrating one embodiment of a method for modeling performance in a part manufactured using an AM process during the step of running the performance model.

FIG. 12A is a flowchart diagram illustrating one embodiment of a method for modeling performance in a part manufactured using an AM process.

FIG. 12B is a flowchart diagram illustrating one embodiment of a method for modeling performance in a part manufactured using an AM process.

FIG. 13 is a flowchart diagram illustrating one embodiment of a method for modeling performance in a part manufactured using an AM process.

FIG. 14 is a perspective view illustrating one embodiment of a portion of a simulated part showing a meshing of the outer surface of the portion of the simulated part.

FIG. 15 is a schematic diagram illustrating one embodiment of a portion of a database for modeling performance in a part manufactured using an AM process.

FIG. 16A is a graph illustrating one embodiment of a plurality of randomly generated points for use in adjusting the surface roughness of a simulated part.

FIG. 16B is a graph illustrating one embodiment of a function fitted to the plurality of points of FIG. 16A.

FIG. 17A is a cutaway side view illustrating one embodiment of a portion of a simulated part for modeling performance in a part manufactured using an AM process.

FIG. 17B is a cutaway side view illustrating one embodiment of the outer surface of the portion of the simulated part of FIG. 17B.

FIG. 18 is a flowchart diagram illustrating one embodiment of a method for modeling performance in a part manufactured using an AM process during the step of running the performance model.

### DETAILED DESCRIPTION

While the making and using of various embodiments of the present disclosure are discussed in detail below, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatus and methods described herein. Such equivalents are considered to be within the scope of this disclosure and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

As used herein, the terms “including,” “comprising,” “having,” and variations thereof mean “including, but not limited to” unless otherwise indicated. An enumerated list of items does not imply that any or all of the items are mutually exclusive or mutually inclusive unless otherwise indicated. The term “or” is not exclusively disjunctive unless otherwise indicated. Thus, the phrase “A or B” is satisfied by A alone, B alone, or A and B together. The term “based on” means “based, at least in part, on” unless otherwise indicated.

The terms “in one embodiment,” “in one or more embodiments,” “in some embodiments,” “in at least one embodiment,” or other similar terms mean “in at least one embodiment, but not necessarily in all embodiments” unless otherwise indicated. The terms “a,” “an,” and “the” mean “one or more” unless otherwise specified.

### OVERVIEW

As a general overview, embodiments of the present disclosure may include systems and methods for modeling performance in a part manufactured using an additive manufacturing (AM) process. In AM, an AM process may produce a part by adding sequential layers of material on top of one another and joining those layers together. For example, in a powder bed fusion (PBF) AM process, a layer of metal powder may be laid down in a laser powder bed, and a laser may heat a portion of the powder. The heated powder may fuse together to form a layer of a part. The part may include a component produced by the AM process. Then, a subsequent layer of metal powder may be laid down in the laser powder bed, and the laser may heat up a portion of the subsequent layer, which may fuse the heated metal powder to each other. In some AM processes, the heated metal powder of a subsequent layer may fuse to the layer below it. In certain AM processes, the heated metal powder of a subsequent layer may not fuse to any material below that layer (e.g., because that portion of the layer may be an overhang). This process of laying down a layer of metal powder and heating portions of it with a laser is repeated until the part is complete.

Sometimes, defects are introduced into the part during the AM process. These defects may include porosity, unmelted particles, grain anisotropy, balling effects, material inhomogeneity, residual stress, or distortion. These defects can be caused by inherent variability in the AM process, such as random distribution of the AM powder, melt pool flow, a denudation process, or other variables.

For example, during the AM process, pores may form in the part. These pores may form in response to the material (such as the metal powder) not being heated sufficiently by the laser such that not all of the material melts and fuses to surrounding material (such pores are known as “lack of fusion” pores). Pores may also form in response to the material being overheated such that the material begins to boil and forms bubbles. The more pores the component has, the higher the component's porosity. Additionally, during the AM process, a surface of the part may form with varying surface roughness. For example, a high-energy density in the AM process may cause a balling effect that may result in high surface roughness.

Certain microstructural properties of an AM-produced part, such as the porosity or the surface roughness, can affect the mechanical performance of that part. Increased porosity can cause the part to perform poorly or have a shorter lifespan than a part with low to no porosity. Variations in a surface's roughness may impede the part from properly interacting with other components. In some embodiments, variations in a surface's roughness may lead to stress concentration points on the surface that may reduce mechanical performance, which may not be desirable. Thus, using software to model such a part with different microstructural properties—including different levels of porosity or surface roughness—and using software that tests a corresponding simulated part with these microstructural properties is desirable.

Modeling performance in a part manufactured using an AM process may include using AM parameters, geometric parameters, or material parameters to generate a process model. The process model may simulate an AM process that produces a simulated part, a simulated temperature history, a surface roughness mapping, or other outputs. The simulated part, the simulated temperature history, the surface roughness mapping, or other output, along with material parameters may be used to generate a microstructure model. The microstructure model may simulate microstructural behavior of the simulated part. The microstructure model may produce a simulated grain structure or a simulated porosity profile for the simulated part. The simulated part, the simulated grain structure, or the simulated porosity profile, along with loading parameters may be used to generate a performance model. The performance model may simulate performing certain testing on the simulated part. The performance model may produce a simulated performance life for the simulated part.

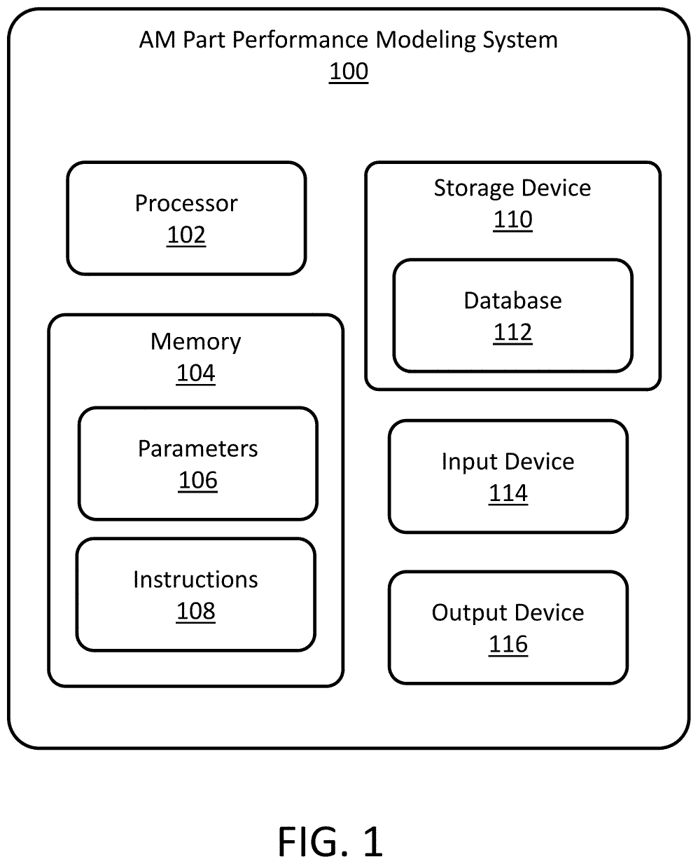

Details of systems and methods for modeling performance in a part manufactured using an AM process are now discussed. FIG. 1 depicts one embodiment of an AM part performance modeling system 100 according to one or more embodiments of the present disclosure. The system may carry out at least a portion of one or more methods for modeling performance in a part manufactured using an AM process. The system 100 may include a processor 102. The system 100 may include a memory 104. The memory 104 may include one or more parameters 106. The memory may include one or more instructions 108. The system 100 may include a storage device 110. The storage device 110 may include a database 112. The system may include an input device 114. The system may include an output device 116.

The processor 102 may include one or more processors. Each processor of the one or more processors may include single-core processor or a multi-core processor. The processor 102 may include central processing unit (CPU), graphics processing unit (GPU), or another type of processor.

The memory 104 may include computer memory. Computer memory may include random access memory (RAM), read-only memory (ROM), a dynamic RAM (DRAM), a synchronous DRAM (SD-RAM), a double data rate (DDR) memory chip, flash memory, volatile or non-volatile memory, cache memory, or another type of memory. The memory 104 may include multiple types of memory. The memory 104 may store data such as the parameters 106 or the instructions 108.

The parameters 106 may include data used by the system 100 for modeling performance in a part manufactured using an AM process. The parameters 106 may include geometric parameters for a part, material parameters for a part, AM parameters for an AM process, or loading parameters for a part, which are discussed below. The parameters 106 may include other parameters or types of data. The instructions 108 may include computer-readable instructions such machine instructions, object code, source code, or other types of instructions. The instructions 108, when executed by the processor 102, may carry out certain functionality of the systems and methods of the present disclosure. In some embodiments, the instructions 108 may include instructions for an integrated computational materials engineering (ICME) software application.

The storage device 110 may include long-term storage such as a hard-drive disk (HDD), optical storage (e.g., a compact disc (CD), digital versatile disk (DVD), a Blu-ray disk), a universal serial bus (USB) device, or other storage devices. The storage device 110 may include a database 112. The database 112 may include a relational database, an object database, a NoSQL database, or another type of database. The database may store certain data used by the instructions 108 or other data in the system 100 to carry out certain functionality of the systems and methods of the present disclosure.

The input device 114 may include a peripheral device such as a keyboard, a mouse, a touchscreen, a microphone, image scanner, or another type of input device. The output device 116 may include a monitor (including a touchscreen), a printer, or some other type of output device.

In one or more embodiments, the system 100 may include a computing device. A computing device may include a personal computer, a laptop computer, a tablet, a workstation, a server, or another type of computing device. A computing device may include a physical machine or a virtual machine (VM). The computing device of the system 100 may include the components of the system 100, such as the processor 102, the memory 104, the storage device 110, the input device 114, or the output device 116.

In some embodiments, the system 100 may include multiple computing devices, and some of these computing devices may be networked together. For example, in some embodiments, the database 112 may be stored on a database server that may be physically separate from the computing devices that includes the processor 102, the memory 104, or at least a portion of the storage device 110. In one embodiment, the system 100 may include a distributed system. The distributed system may include multiple computing devices that are networked together and that send and receive data across the network. Each computing device of the distributed system may include a processor, a memory, a storage device, an input device, or an output device, each of which may respectively belong to the processor 102, the memory 104, the storage device 110, the input device 114, or the output device 116. One or more processors 102 of the distributed system may execute the instructions 108 in a distributed manner.

In some embodiments, certain data stored on the storage device 110 may be copied or moved to the memory 104 or vice versa. The database 112 may be stored all or partially in both the memory 104 or the storage device 110.

### Porosity

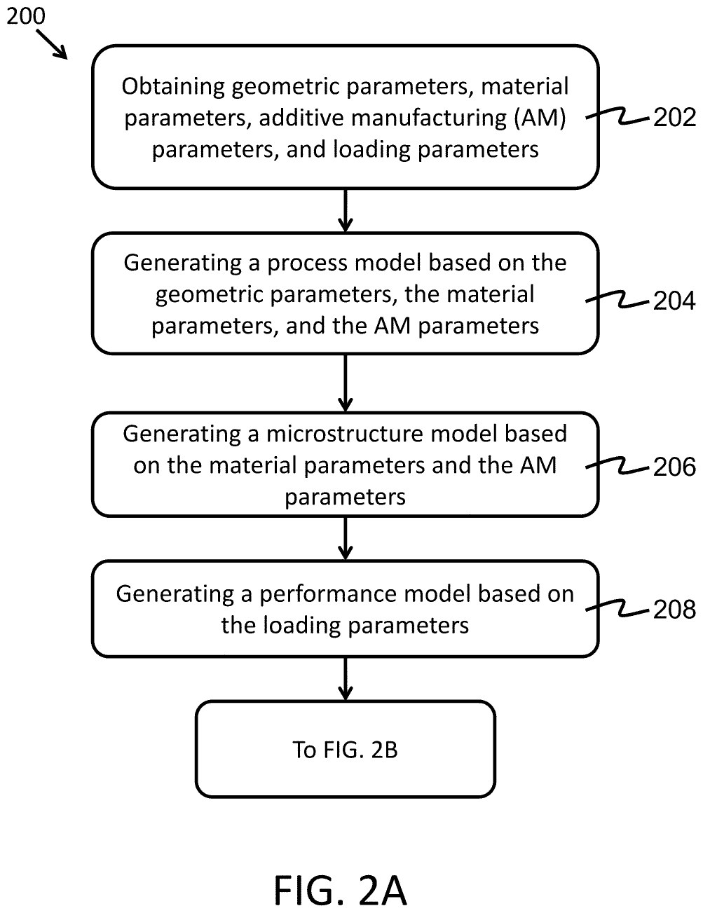

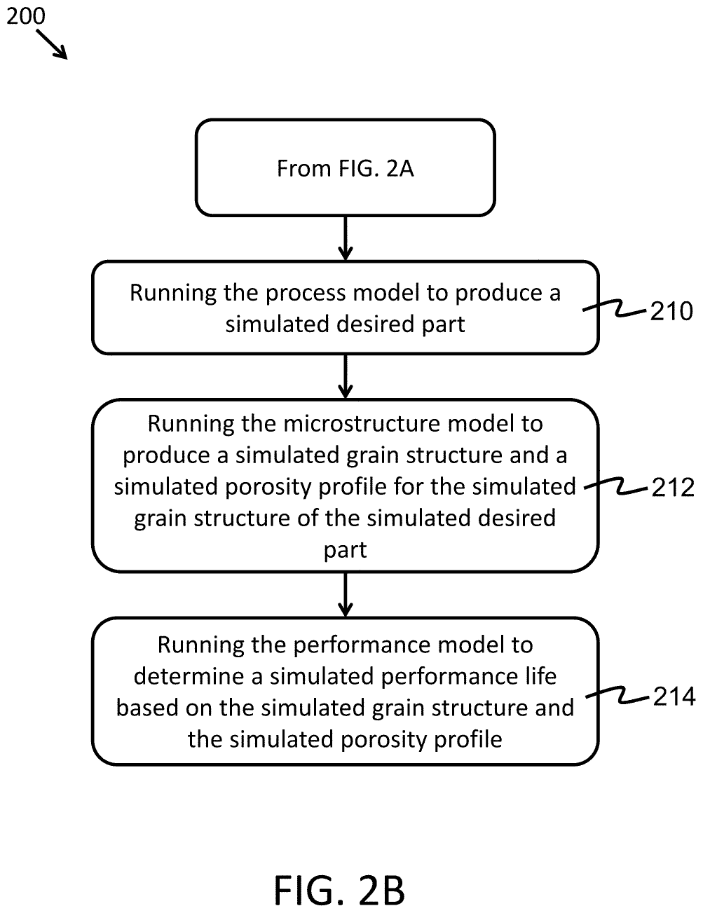

FIG. 2A and FIG. 2B depicts one embodiment of a method 200 for modeling performance in a part manufactured using an AM process. In some embodiments, the system 100 may carry out one or more steps of the method 200. The method 200 may include obtaining geometric parameters or material parameters for the part, AM parameters for the AM process, or loading parameters for the part (step 202). The method 200 may include generating a process model based on the geometric parameters, the material parameters, or the AM parameters (step 204). The method 200 may include generating a microstructure model based on the material parameters or the AM parameters (step 206). The method 200 may include generating a performance model based on the loading parameters (step 208).

The method 200 may include performing performance simulation by running the process model to produce a simulated part (step 210). Performing performance simulation may include running the microstructure model to produce a simulated grain structure or a simulated porosity profile for the simulated grain structure of the simulated part (step 212). Performing performance simulation may include running the performance model to determine a simulated performance life based on the simulated grain structure or the simulated porosity profile (step 214).

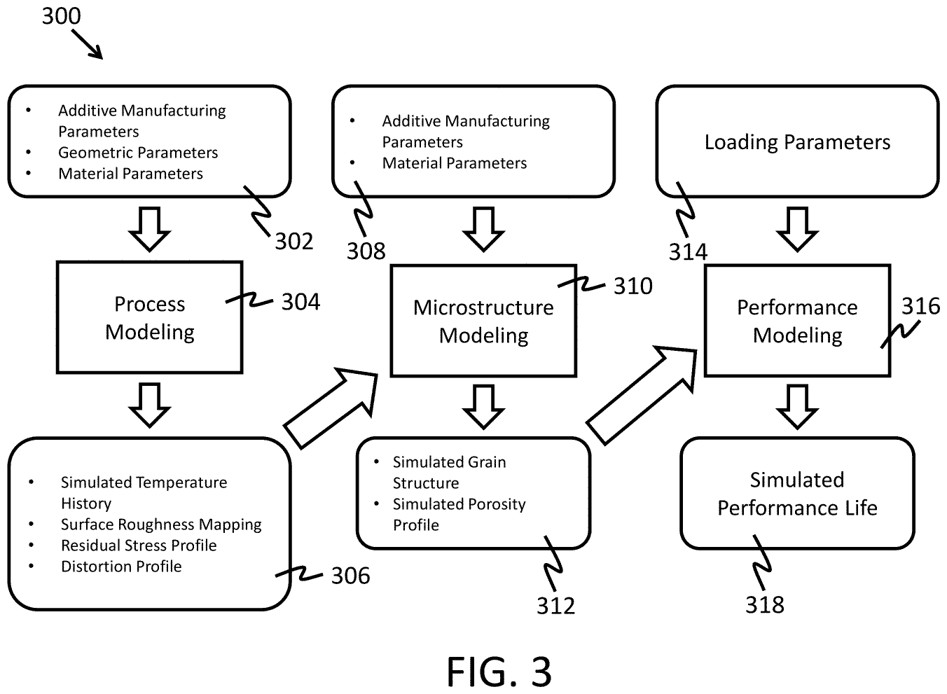

FIG. 3 depicts one embodiment of a flowchart 300. The flowchart 300 may depict the flow of data and the performance of actions in one embodiment of the method 200 of FIG. 2A and FIG. 2B. As can be seen in FIG. 3, the AM parameters, the geometric parameters, or the material parameters 302 (which may be a portion of the one or more parameters 106 and may have been obtained as part of step 202 of the method 200) may be used as input to a process modeling 304. The process modeling 304 may include generating the process model (step 204). The processing modeling 304 may include running the process model (step 210). The process modeling 304 may generate one or more outputs 306, which may include a simulated temperature history for the simulated part, a surface roughness mapping of the simulated part, a residual stress profile of the simulated part, or a distortion profile of the simulated part.

One or more outputs 306 of the process modeling 304 may be used as input to the microstructure modeling 310, along with the material parameters or the AM parameters 308 (which may be a portion of the one or more parameters 106 and may have been obtained as part of step 202). The microstructure modeling 310 may include generating the microstructure model (step 206). The microstructure modeling 310 may include running the microstructure model (step 212). The microstructure modeling 310 may generate one or more outputs 312, which may include the simulated grain structure or the simulated porosity profile.

One or more outputs 312 of the microstructure modeling 310 may be used as input to the performance modeling 316, along with the loading parameters 314 (which may be a portion of the one or more parameters 106 and may have been obtained as part of step 202). The performance modeling 316 may include generating the performance model (step 208). The performance modeling 316 may include running the performance model (step 214). The performance modeling 316 may generate one or more outputs 318, which may include the simulated performance life of the simulated part.

In one embodiment, the geometric parameters may include geometric- or shape-related properties of at least a portion of the part. The geometric parameters may include part geometry of the part. The geometric parameters may include a size (e.g., length, width, or height; volume), shape, orientation, or location of a portion of the part. A portion of the part may include a section, a facet, a surface, an angle, a void, an extremity, or another portion of the part. The geometric parameters may include a surface angle (sometimes called an “overhang angle”) of the part. The geometric parameters may include one or more three-dimensional computer-aided design (CAD) files or a portion of a CAD file of the part.

In some embodiments, the material parameters may include one or more properties of the one or more materials of which the part is comprised. The material parameters may include the type of material, for example, steel, titanium, Ferrium, or some other metal or metal alloy. The material parameters may include a form of the material, for example, a powder, a liquid, a wire, a sheet, or some other form. The material parameters may include a boiling point temperature or a melting point temperature. The material parameters may include fracture energy per unit area or facture toughness. The material parameters may include frictional stress, hardness, conductivity, heat capacity, laser absorbability, or thermal expansion. The material parameters may include elasticity, plasticity, corrosion resistance, wear resistance, density, ductility, malleability, stiffness, strength (fatigue, shear, tensile, yield, etc.). The material parameters may include other material parameters.

In one or more embodiments, the AM parameters may include properties of the AM process. The AM parameters may include laser power parameters, laser scanning speed parameters (sometimes called “laser speed” or “scanning speed”), a laser scanning pattern, a laser beam shape, a laser beam size, a laser spot size, or an energy density. The AM parameters may include a powder layer thickness, hatch spacing parameters, a pre-heat temperature, or scan rotation parameters. The AM parameters may include other AM parameters.

In one embodiment, the loading parameters may include an external load applied to the part as a displacement or a force. The loading parameters may include loading caused by residual stress at the end of an AM process, loading caused by residual stress resulting from heat treatment or post-processing treatment (e.g., machining). The loading parameters may include one or more forces, application angles, loading frequencies, or other parameters that may be used to calculate the fatigue life.

In one embodiment, obtaining one or more parameters 106 (e.g., as part of the step 202) may include obtaining the parameters 106 at the system 100. In some embodiments, obtaining the one or more parameters 106 (step 202) may include loading the one or more parameters 106 into the memory 104. For example, a computer file (e.g., a CAD file that may include one or more of the geometric parameters) may store one or more parameters 106, and obtaining the one or more parameters 106 (step 202) may include the processor 102 reading the computer file and loading data read from the file into the memory 104. The computer file may be stored in the storage device 110. The system 100 may receive the computer file over a data network from another computing device. In one embodiment, the database 112 may store the one or more parameters 106, and database management software (DBMS) may read the parameters 106 from the database 112 and load them into the memory 104. In some embodiments, a user may input one or more of the parameters 106 via the input device 114. In another embodiment, the system 100 may receive the one or more parameters 106 may over a network (e.g., from a webserver). In one or more embodiments, with the one or more parameters located in the memory 104, the one or more computer-readable instructions 108 may be ready to use the parameters 106 in predictive modeling of AM parts functionality when executed by the processor 102.

In some embodiments, the process model may include a physics-based multiscale or thermo-mechanical model of the part. Generating the process model (step 204) may include receiving one or more of the parameters 106 as input. The input parameters of the process model may include the geometric parameters, the material parameters, or the AM parameters.

In some embodiments, running the process model (step 210) may occur in response to generating the process model (step 204). Running the process model (step 210) may include generating a simulated part. The simulated part may include a simulation of a corresponding part. In one embodiment, running the process model (step 210) may include simulating at least a portion of the AM process to generate the simulated part. Running the process model (step 210) may include simulating the formation of the simulated part by adding sequential layers of material on top of one another according to the AM parameters. For example, the AM process may include heating metal powder with a laser beam to form the metal powder into a layer of the part, and running the process model (step 210) may include simulating applying heat to simulated metal powder to form a simulated layer of the simulated part. Simulating applying heat may simulate the thermal and mechanical behavior of materials at one or more layers of the simulated part. Running the process model (step 210) may include a simulation of the cyclic and rapid heating and cooling phenomenon in the AM process. Such a phenomenon may modify the microstructure of the simulated part.

In some embodiments, running the process model (step 210) may include using a two-step finite element analysis (FEA). The two steps of the two-step FEA may include a thermal analysis and a mechanical analysis. The thermal analysis may include a thermal model of the simulated part and may simulate the temperature evolution or thermal stress for one or more laser scans or layers of the simulated part. The thermal model may simulate an energy source represented by a physics-based model of a heat flux that may consider laser power, scan speed, or hatch spacing. Temperature-dependent or material state-dependent properties may be incorporated into the simulation to accurately simulate the heat transfer phenomenon in the AM process. The mechanical analysis may include a mechanical model, and may simulate the thermal stress or thermal strain induced by the temperature gradient. The mechanical analysis may obtain the inherent strain tensor.

In one embodiment, at the macro-scale, the process model may partition the simulated part into one or more lumping layers along the build direction. A lumping layer may include multiple physical layers. The process model may activate the one or more lumping layers may activated one-by-one, and may apply the inherent strain sequentially. The bottom of the build plate may be fixed during the simulation.

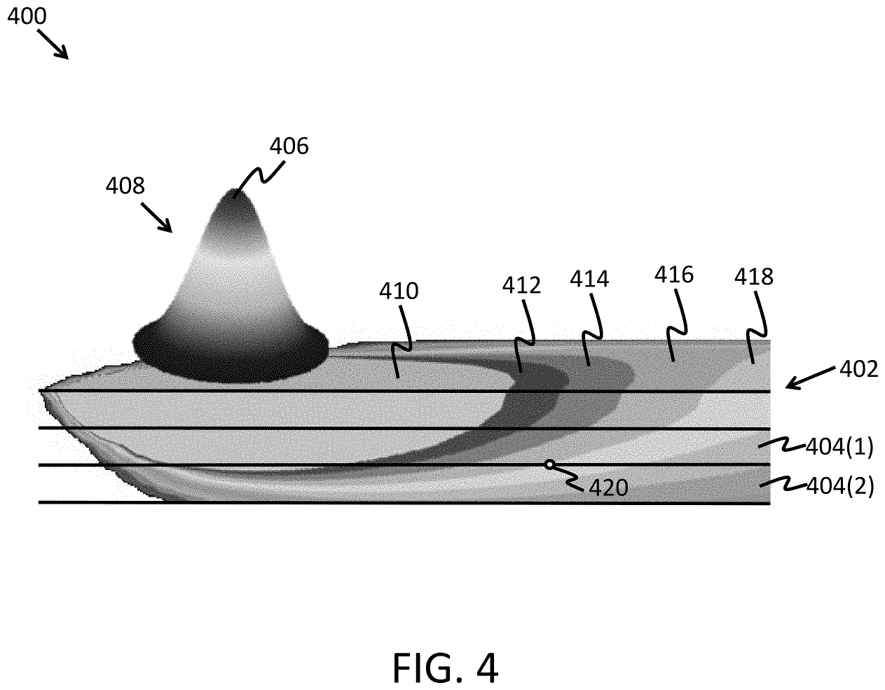

FIG. 4 depicts a cutaway perspective view of one embodiment of running the process model (210) to simulate applying heat to simulated metal powder to form a simulated layer of the simulated part. This may be part of the thermal analysis of the two-step FEA. FIG. 4 depicts a portion 400 of the simulated part. The portion 400 may include a top layer 402 and two previous layers 404(1) and 404(2). While FIG. 4 depicts three total layers 402, 404(1), and 404(2) at this stage of running the process model (step 210), the portion 400 could, in some embodiments, include any number of layers 402, 404(1)-(n). The portion 400 may include a simulated heat flux 406. The simulated heat flux 406 may simulate a heat source that may simulate heating metal powder with a laser beam to form the metal powder into a layer of a part. The simulated heat flux 406 may simulate a simulated laser beam 408. The simulated laser beam 408 may simulate applying heat to portions of the portion 400. For example, as seen in FIG. 4, the simulated laser beam 408 may simulate applying heat to one or more layers 402, 404(1), 404(2) of the portion 400. As can also be seen from FIG. 4, the simulated laser beam 408 may not only apply heat to the top layer 402, but may also apply heat to one or more previous layers 404(1), 404(2).

In some embodiments, the simulated heat flux 406 may move in relation to the portion 400. The simulated heat flux 406 may move in the scanning direction. For example, FIG. 4 depicts the portion 400 after the simulated heat flux 406 (and the simulated laser beam 408) has move from the right side of FIG. 4 to the left side. In some embodiments, the intensity of the heat flux 406 may be calculated according to the equation:

$$I = \frac{A P}{π {r}^{2}} exp ( - {B ( \frac{r}{{r}_{0}} )}^{2} )$$

where I is the laser intensity, A is the laser absorption coefficient (which, in some embodiments, may depend on the laser type, material, or powder size), P is the laser power, r₀ is the laser spot radius, B is the shape factor of the Gaussian distributed heat flux (which may be 2 in some embodiments), and r is the distance to laser beam center. For other energy sources (such as an electron beam etc.), a different coefficient or thermal model may be used to match the physical mechanism. The AM parameters may include one or more of these variables.

In one embodiment, the simulated laser beam 408 may apply heat to sections of the portion 400 such that a simulated melt pool 410 may form in a section of the portion 400. A melt pool 410 may include a portion of a part where the material (such as the metal powder or a portion of the part that was previously formed) is heated to a temperature such that the material becomes a liquid. For example, as seen in FIG. 4, a melt pool 410 has been formed in multiple layers 402, 404(1), 404(2) of the portion 400.

In one embodiment, the simulated heat flux 406 or the simulated laser beam 408 may be customized or calibrated based on the AM parameters. This may allow the process model to simulate different types of heat fluxes, laser beams, or other heat sources.

In one or more embodiments, the simulated part may include portions that include different temperatures. For example, in FIG. 4, the melt pool 410 may include a first temperature range, a second portion 412 of the portion 400 may include a second temperature range, a third portion 414 may include a third temperature range, a fourth portion 416 may include a fourth temperature range, and a fifth portion 418 may include a fifth temperature range. Each of the first through fifth temperatures range may be different from each other. For example, in FIG. 4, the first temperature range (i.e., the temperature range of the melt pool 410) may be the highest temperature range, followed by the second temperature range, the third temperature range, the fourth temperature range, and the fifth temperature range (which may be the coolest of the five temperature ranges). The different temperature ranges may include overlapping ranges or may not include overlapping ranges. In some embodiments, the temperatures of one or more of the portions 410-418 may include a temperature at a certain time or may include a maximum temperature that the portion 410-418 experienced during the simulated AM process.

In one embodiment, the simulated part may simulate a state of matter for a portion of the part based on that portion's temperature. For example, as depicted in FIG. 4, running the process model (step 210) may include simulating the melt pool 410 as a liquid in response to the melt pool's 410 temperature being above the melting point temperature of the material of that portion of the portion 400. Running the process model (step 210) may include simulating the second portion 412 of the portion 400 as a solid in response to the second portion's 412 temperature being bellow the melting point temperature of the material of the second portion 412.

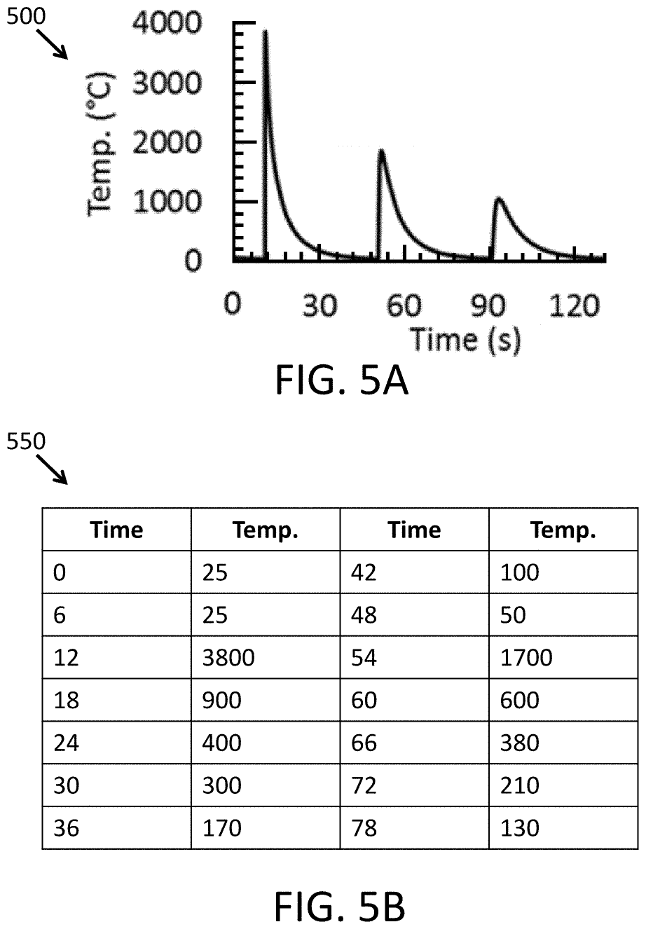

In some embodiments, running the process model (step 210) may include producing a simulated temperature history. The simulated temperature history may include a location on the simulated part, a temperature value, and the time at which that location experienced that temperature value. The simulated temperature history may include multiple locations on the simulated part, each with their own corresponding temperature value(s) and corresponding time(s). FIG. 5A depicts one embodiment of a graph 500 showing the simulated temperature history of a point 420 of the portion 400 of FIG. 4. As can be seen from the graph 500, the temperature of point 420 was near 0 degrees Celsius from t=0 second to about t=12 seconds. During this time, the point 420 may have simulated metal powder that had not yet been heated by the simulated laser beam 408. At about t=12 seconds, the simulated laser beam may have simulated heating the point 420, and, in response, the temperature of the point 420 may have reached about 4800 degrees Celsius. From about t=12 second to t=50, the temperature of the point 420 may have dropped exponentially. During this time, the simulated laser beam 408 may have been simulating heating other portions of the simulated part. At about t=50 seconds, the simulated laser beam 408 may have heated simulated metal powder that had been placed above the point 420, and the temperature of the point 420 may have reached about 1800 degrees Celsius. From about t=50 seconds to about t=91 seconds, the temperature of the point 420 may have dropped exponentially. Again, during this time, the simulated laser beam 408 may have been simulating heating other portions of the simulated part. At about t=91 seconds, the simulated laser beam 408 may have heated simulated metal powder and the layer above the point 420, and the temperature of the point 420 may have reached about 1100 degrees Celsius. From about t=91 seconds to about t=132 seconds, again the temperature of the point 420 may have dropped exponentially. FIG. 5B depicts a table 550. The table 550 depicts a portion of the same data as graph 500 of FIG. 5A in table form.

In some embodiments, the process model may compute the temperature of the point of the simulated part at one or more intervals. For example, the temperature may be computed every 10 seconds, every second, every 0.1 second, every 0.01 second, every 0.001 seconds, at some other interval between every 10 and every 0.001 seconds, at some interval greater than every 10 second, or at some interval less than every 0.001 seconds. In one or more embodiments, the number of simulated points where temperature is computed may be one point, 100 points, 1,000 points, 10,000 points, 100,000 points, 1 million points, 10 million points, a number of points between 1 and 10 million, or a number of points greater than 10 million.

In one embodiment, running the process model (step 210) may include producing a simulated temperature history of the simulated part. Producing a simulated temperature history of the simulated part may include producing a simulated temperature history for one or more points (such as the point 420 of FIG. 4) of the simulated part.

Running the process model (step 210) may include producing a residual stress profile within the simulated part. Residual stress may include a stress that remains in the part after the original cause of the stress may have been removed. Residual stress may be measured in megapascals (MPa) or other similar units. Residual stress may include a direction indicator that may indicate the direction of the stress (e.g., positive may indicate a first direction, and negative may indicate a second direction). A residual stress profile may include one or more points on the simulated part, the amount of residual stress in the corresponding point on the simulated part, and other data related to residual stress corresponding to that point. In one or more embodiments, the number of simulated points where residual stress is computed may be one point, 100 points, 1,000 points, 10,000 points, 100,000 points, 1 million points, 10 million points, a number of points between 1 and 10 million, or a number of points greater than 10 million.

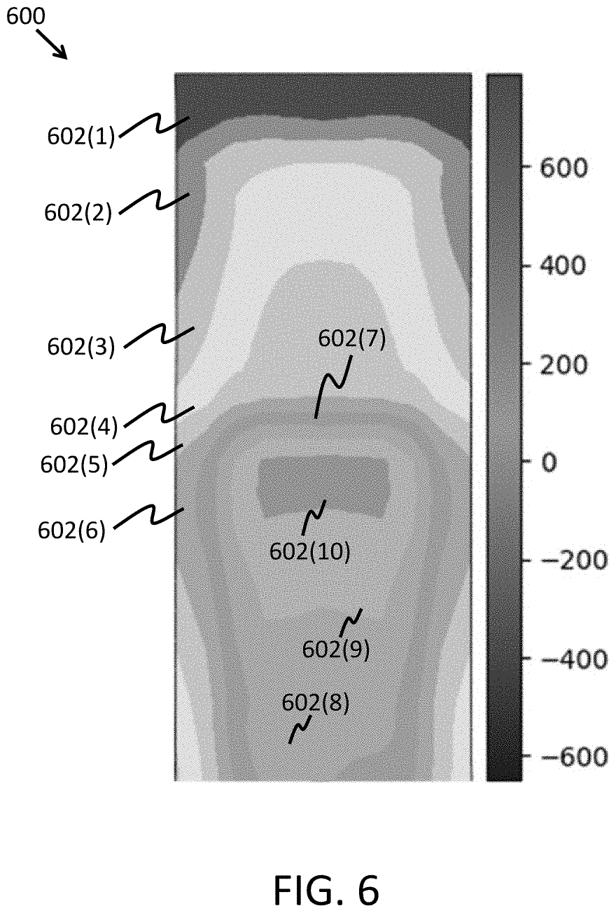

FIG. 6 depicts one embodiment of a residual stress profile 600. The residual stress profile 600 may correspond to a portion of the simulated part. For example, the residual stress profile 600 may correspond to a single layer of the simulated part, or may correspond to multiple layers. As can be seen from FIG. 6, running the process modeling (step 210) may generate the residual stress profile 600 with each point in the profile including an amount of residual stress as measured in megapascals. For example, points in the first portion 602(1) may include a residual stress amount of about 600 MPa, points in the second portion 602(2) may include a residual stress amount of about 550 MPa, and the other portions 602(3)-(10) may include corresponding residual stress amounts.

Running the process model (step 210) may include producing a distortion profile for the simulated part. Distortion in the part may include a portion of the part bending or moving out of place. Distortion may occur when a portion of the part separates from the substrate or may occur before or after the portion of the part separate from the substrate. The portion may separate in response to a lack of fusion, a high amount of heat that may cause the portion to warp, or in response to other events. Distortion may include a magnitude or direction. The magnitude may be measured in millimeters or some other distance unit of measurement, and the direction may be indicated by a positive negative, or zero value. The distortion profile may include one or more portions of the simulated part and an amount of distortion corresponding to each of those portions. In one or more embodiments, the number of simulated points where distortion is measured may be one point, 100 points, 1,000 points, 10,000 points, 100,000 points, 1 million points, 10 million points, a number of points between 1 and 10 million, or a number of points greater than 10 million.

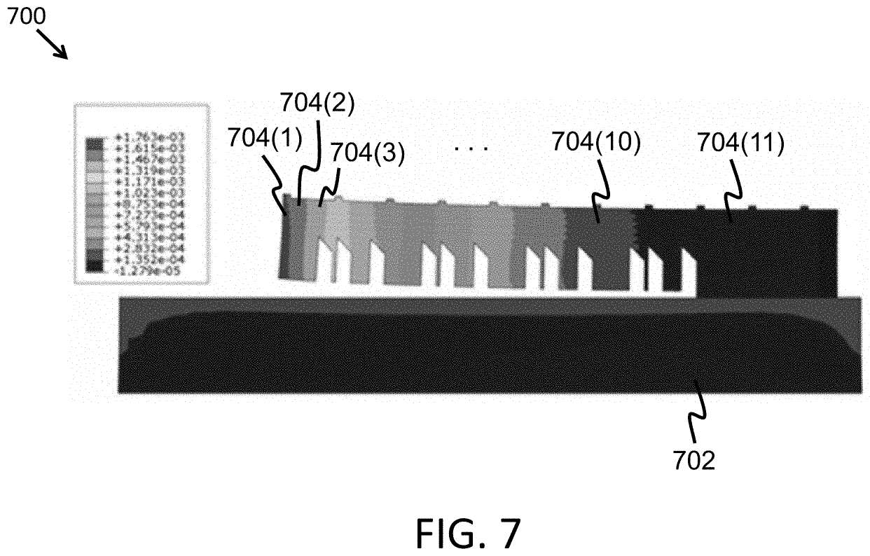

FIG. 7 depicts one embodiment of a distortion profile 700. The distortion profile 700 may correspond to a portion of the simulated part. As can be seen from FIG. 7, running the process model (step 210) may generate the distortion profile 700. The distortion profile 700 may include multiple portions, and each portion may include a corresponding amount of distortion measured in millimeters. For example, the distortion profile 700 may include a simulated substrate 702. The distortion profile 700 may include a first portion 704(1). The first portion 704(1) may include a portion of the simulated part that has separated from the substrate 702 by about 1.763 mm. The second portion 704(2) may include a portion of the simulated part that has separated from the substrate 702 by about 1.615 mm. The third portion 704(3) may include a portion of the simulated part that has separated from the substrate 702 may about 1.467 mm. The distortion profile 700 may include further portions 704(4)-(10) of simulated part. The distortion profile 700 may include a portion 704(11) that is connected to the substrate 702.

Running the process model (step 210) may include producing a surface roughness mapping for the simulated part. Producing the surface roughness mapping is discussed further below. In some embodiments, running the process model (step 210) may include generating output. The output of running the process model (step 210) may include a simulated part. The output may include a simulated temperature history. The output may include a residual stress profile. The output may include a distortion profile. The output may include a surface roughness mapping. The output may include other data generated by running the process model (step 210).

Running the microstructure model (step 212) may include producing a simulated grain structure or a simulated porosity profile for the simulated grain structure of the simulated part. In some embodiments, the microstructure model may include a simulation of microstructural features of the simulated part. The microstructure model may predict one or more microstructure features of the simulated part. The microstructural features may include grain structure, grain texture, grain morphology, grain size, porosity, melt pool properties, microstructural inhomogeneities, surface roughness, or other features. In one embodiment, generating the microstructure model (step 206) may include taking one or more of the parameters 106 as input. The input parameters of the process model may include the material parameters or the AM parameters. Generating the microstructure model (step 206) may include receiving one or more outputs of the process model. The one or more outputs may include a simulated temperature history, a residual stress profile, or a distortion profile.

In one or more embodiments, the microstructure model may simulate one or more phenomena of AM. These phenomena may include grain nucleation or solidification behavior. The microstructure model may include, employ, or use a Kurz-Giovanola-Trivedi (KGT) model that may account for kinetic effect by importing a growth velocity of liquid/solid interface as a function of undercooling. The microstructure model may simulate or model a nonequilibrium status because the simulation domain may have different undercooling based on a temperature (e.g., from the simulated temperature history outputted from the process model). In some embodiments, the material parameters of the one or more parameters 106 may include one or more coefficients. Different alloy systems may have different coefficient values, which may cause them to behavior differently. The material parameters may calibrate the microstructure model coefficients that may be used during simulation.

In one embodiment, the microstructure model may include a physics-based model (such as the KGT model) to predict one or more microstructure features, produce the simulated grain structure, or produce the simulated porosity profile. In some embodiments, the microstructure model may include a machine learning model. The machine learning model may generate one or more of the predictions. In another embodiment, the microstructure model may include a combination of a physics-based model and a machine learning model. The machine learning model may include one or more instances of a machine learning model. An instance of a machine learning model may include an artificial neural network (ANN) (including a back propagation neural network, a deep learning neural network, a convolutional neural network, a recurrent neural network, or some other type of ANN), linear regression, a Bayesian model, a decision tree, a clustering model, or another type of machine learning model.

The microstructure model may include a finite element cellular automata (FE-CA) method. The FE-CA method may simulate microstructure evolution of the simulated part. In one embodiment, the microstructure model may select data from the simulated temperature history of a portion of the simulated part. The portion may include a selected cross-section. The microstructure model may project the simulated temperature history to a two-dimensional cellular automata domain with a refined grid size. The microstructure model may simulate solidification behavior.

The FE-CA method may be based on an algorithm that may describe discrete spatial and temporal evolution of a simulated part. The FE-CA method may model grain structure formation in different solidification processes, including casting, welding, AM, and other processes. In some embodiments, the FE-CA method may include the advantage of good computational efficiency while still maintaining the physics-based algorithm in the modeling.

In one embodiment, the microstructure model may discretize the domain into a finite number of small squares, called cells. Each cell may include one or more parameters, including material state (e.g., liquid or solid), temperature, grain orientation, or solute concentration. The growth of grains may be represented by more and more cells changing the state from liquid to solid. The nucleate may grow as a square envelope (representative of a cubic phase in two dimensions) whose corner may align with the crystallographic orientation. The grow length can be calculated by the following equation:

$$L = {\sum }_{t} v ( T ) \times Δ t$$

where L is the grow length (which may be half width of the envelope diagonal), Δt is the time increment in the simulation, and v(T) is the local growth velocity, which may include a function of temperature. In response to an envelope touching its neighboring cells, which may be in liquid states, the neighboring cells may then change from a liquid state to solid and may inherit a crystallographic orientation. Then, the touched cells may grow with their own velocity from the touch point and may capture other liquid cells after a certain amount of time. This process may continue. The process may stop, for example, if the domain becomes solid cells. At this point, the grain growth may be complete.

In the simulation carried out by the microstructure model, the simulated temperature history at each timestep may be mapped from the finite element method model into the cellular automata domain, and the temperature at each cell may drive the grain nucleation and growth.

Grain nucleation in a melt pool (for example, the melt pool 410) may determine the final grain size and morphology. Pure epitaxial growth without grain nucleation may result in columnar dendritic grains in rapid solidification. Heterogeneous grain nucleation in the melt pool may lead to mixed columnar and equiaxed grain structures. The microstructure model may implement Thevoz's statistical model that may account for heterogeneous nucleation in solidification. The microstructure model may describe the heterogeneous nucleation sites as a function of undercooling temperature, as follows:

$$n ( Δ T ) = {\int }_{0}^{Δ T} \frac{d n}{d ( Δ {T}^{′} )} d ( Δ {T}^{′} )$$

where n(ΔT) is the grain nucleation density at given undercooling (ΔT) and dn/d(ΔT) is a Gaussian distributed nucleation distribution.

As seen in the equation for grow length L, above, grain growth velocity v(T) may assist with accurate predictions. In some embodiments, the microstructure model may account for kinetic effects via importing the growth velocity of liquid/solid interface as a function of undercooling as shown in the equation:

$$v ( Δ T ) = {\sum }_{m} {b}_{m} \times {( Δ T )}^{m} ( m = 1 , 2 , … , N )$$

where bm and m are constants. This equation was derived from KGT model using phase field simulation. The non-equilibrium status may be modeled because the simulation domain may have different undercooling based on process modeling of temperature. In some embodiments, different alloy systems may include different coefficient values (bm) and may behave differently. For each alloy system, coefficients of bm and m may be calibrated.

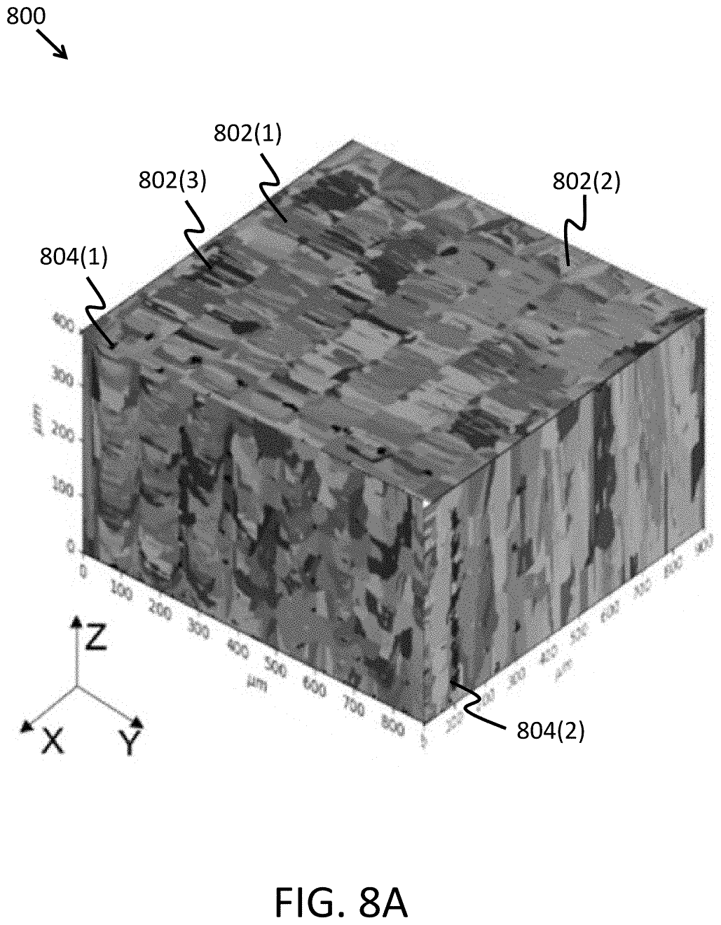

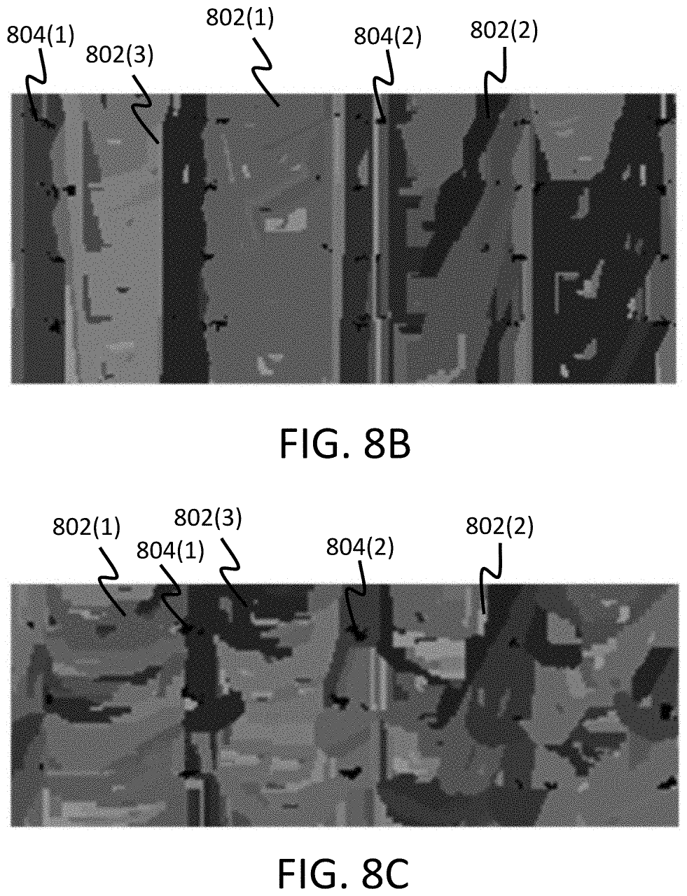

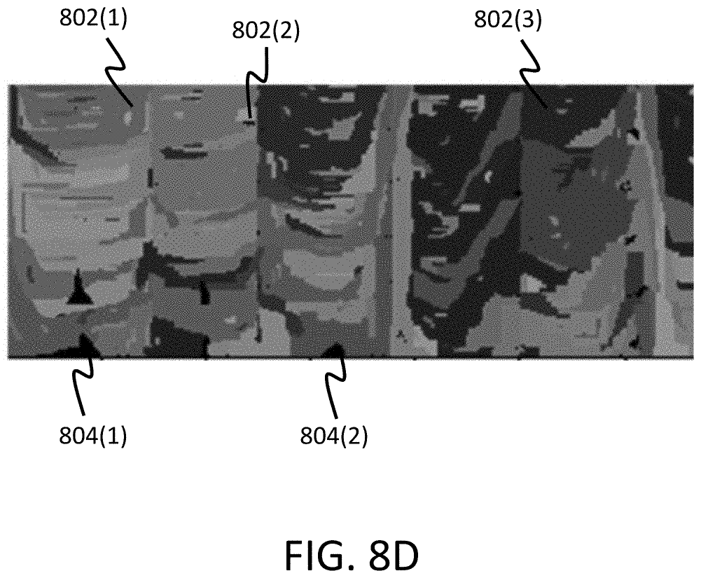

FIG. 8A depicts one embodiment of a portion 800 of the simulated part. The portion 800 may include a portion of the simulated part that may be simulated in or by the microstructure model. The “X” direction of the portion 800 may include the laser travel direction. The “Y” direction may include the hatch direction. The “Z” direction may include the building direction. The colors of the portion 800 may correspond to a grain orientation. A grain orientation may range from 0 degrees to 90 degrees.

In one or more embodiments, the microstructure model may simulate or account for porosity in the simulated part. The microstructure model may incorporate temperature evolution (e.g., in the form of a simulated temperature history) from an output of the process model and use it as input to the microstructure model. The microstructure model may correlate a temperature (e.g., from the simulated temperature history) of the simulated part with porosity. For example, a simulated melt pool of the simulated part from the process model may be correlated with a lack-of-fusion porosity. In another example, a portion of the simulated part that experienced excessive energy density during the process model simulation may correlate with keyhole or boiling porosity.

In some embodiments, the porosity of the simulated part may be based on the AM parameters. For example, the porosity may be based on the laser power of the simulated AM process of the process model. FIG. 8B depicts a portion of the portion 800 where the simulated AM process used a 160 Watt laser power, FIG. 8C depicts the portion of the portion 800 where the simulated AM process used a 320 Watt laser power, and FIG. 8D depicts the portion of the portion 800 where the simulated AM process used a 400 Watt laser power. As can be seen from the FIGS. 8B-D, the porosity of the portion of the portion 800 may differ based on the laser power. For example, the locations of simulated pores 804, the sizes the simulated pores 804, the dimensions of the simulated pores 804, or other porosity properties may differ based on different AM parameters.

In one embodiment, running the microstructure model (step 212) may include producing a simulated porosity profile based on a simulated temperature history. The microstructural model may receive simulated temperatures from a simulated temperature history generated by the running process model (step 210). In some embodiments, the porosity profile may include a value indicating a porosity of the simulated part, a portion of the simulated part, or another aspect of the simulated part. In one embodiment, the simulated porosity profile may include one or more simulated pores. Each simulated pore of the simulated porosity profile may include a position in the simulated part (e.g., as represented by an (x, y, z) coordinate), one or more dimensions of the pores, data about the size or shape of the pore, or other pore data. FIG. 8A depicts the portion 800 including one or more simulated pores 804(1), (2).

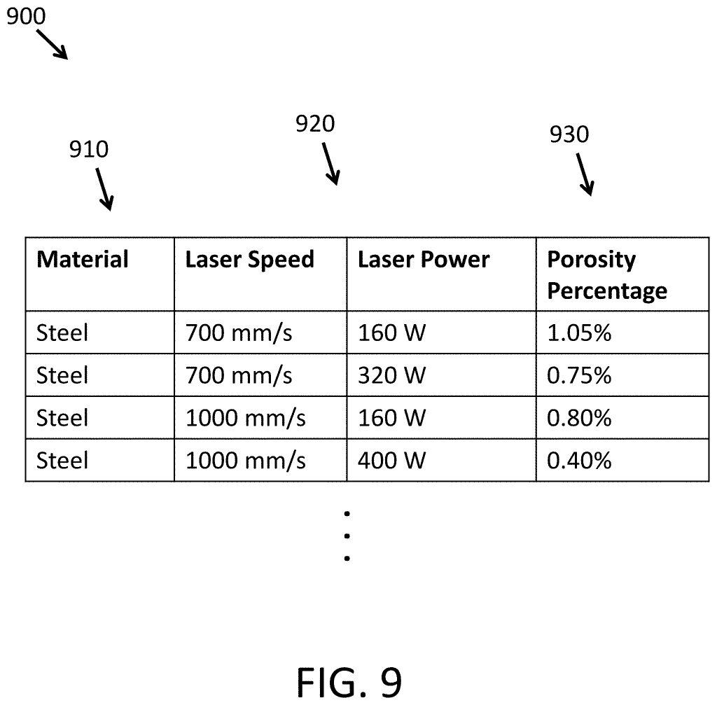

In some embodiments, running the microstructure model (step 212) may include querying, using the material parameters (of the one or more parameters 106), a database 112 of experimental material parameters, experimental AM parameters, or corresponding porosity properties to produce the simulated porosity profile. In one embodiment, the porosity properties may include a porosity percentage. FIG. 9 depicts one embodiment of a portion 900 of the database 112. The portion 900 of the database 112 may include a table (e.g., in a SQL database). The portion 900 may include one or more experimental material parameters 910. For example, as depicted in FIG. 9, the experimental material parameters 910 may include a type of metal or alloy. The portion 900 may include one or more experimental AM parameters 920. For example, as depicted in FIG. 9, the experimental AM parameters 920 may include a laser speed and a laser power. The portion may include one or more corresponding porosity properties 930. For example, as depicted in FIG. 9, the porosity properties 930 may include a porosity percentage.

In one embodiment, querying the database may include using a query that includes one or more experimental material parameters or experimental AM parameters. In some embodiments, querying the database may include returning the corresponding porosity parameters. For example, a query may include that the material is “Steel,” that the laser speed is “700 mm/s” and the laser power is “160 W.” In response to processing the query, the database 112 may return 1.05% as the corresponding porosity properties. In some embodiments, the query parameters may match the experimental material parameters and experimental AM parameters. In one embodiment, the database 112, a DBMS, or some other program may calculate which database record most closely matches the query. The database 112, DBMS, or other program may use a matching method to select the database record. The matching method may include nearest neighbor, optimal pair, optimal full, or some other matching method.

In some embodiments, the porosity percentage may be received from source other than the database 112. For example, the porosity percentage may be received from the input device 114 as user input, or the porosity percentage may be received from a file stored in memory 104 or the storage device 110. In some embodiments, running the microstructure model (step 212) may include randomly adding pores to the simulated grain structure until the porosity percentage is achieved.

In one or more embodiments, running the microstructure model (step 212) may include identifying two or more porosity zones in the simulated grain structure based on the simulated temperature history. Identifying the two or more porosity zones may include identifying, based on the simulated temperature history a lack-of-fusion area of the simulated part or a boiling area of the simulated part. As described above, the lack-of-fusion area may include an area of the simulated part where a simulated temperature history may indicate that the area was not heated sufficiently by a simulated heat source such that not all of the simulated material in the area melts and fuses to surrounding material. Also as described above, a boiling area may include an area of the simulated part where its simulated temperature history may indicate that the area was overheated such that the simulated material began to boil and forms bubbles. In one embodiment, the material parameters may include a material boiling point temperature, and identifying the boiling area of the simulated part may include identifying, from the simulated temperature history, an area of the simulated part where a temperature of the identified area exceeds the material boiling temperature.

In some embodiments, running the microstructure model (step 212) may include correlating each porosity zone to a predetermined corresponding porosity percentage, and randomly adding pores to each porosity zone of the simulated grain structure until the predetermined corresponding porosity percentage is achieved. The predetermined corresponding porosity percentage may include the porosity percentage returned from the database 112. The porosity percentage may include a value based on user input, or based on some other process or calculation.

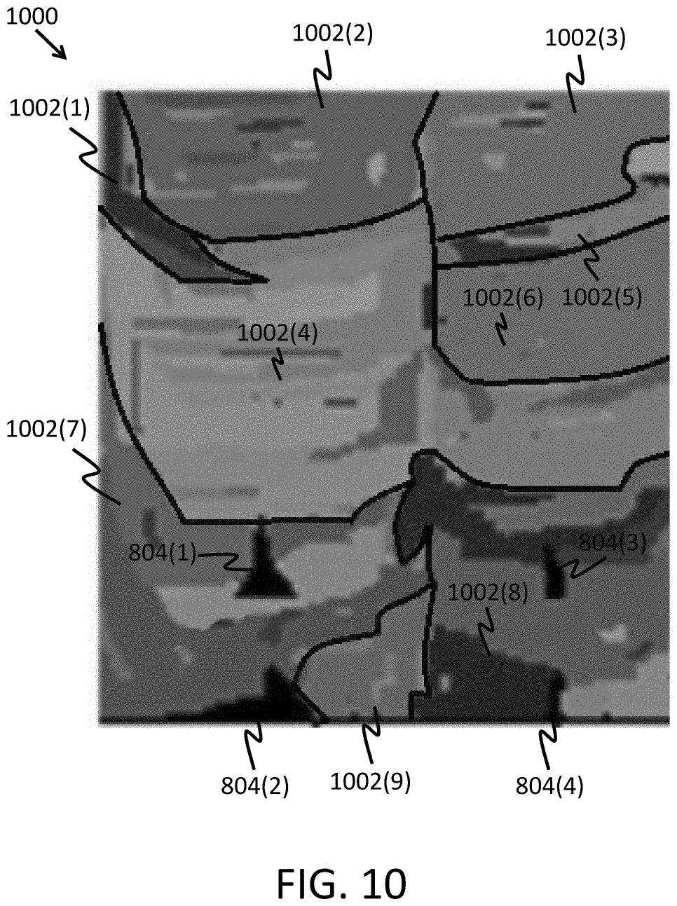

FIG. 10 depicts one embodiment of a portion 1000 of the simulated part. Similar to FIGS. 8A-D, FIG. 10 may depict the portion 1000 with different colors that may correspond to a grain orientation of the portion 1000. The portion 1000 may include one or more porosity zones 1002(1)-(9). As can be seen in FIG. 10, the first six porosity zones 1002(1)-(6) and the ninth porosity zone 1002(9) may not include any simulated pores 804. The seventh porosity zone 1002(7) may include two simulated pores 804(1)-(2). As can be seen from FIG. 10, the simulated temperature history of the porosity zone 1002(7) may show that the porosity zone 1002(7) experienced relatively high temperatures during the simulated AM process. Thus, the porosity zone 1002(7) may include a boiling area, and in response, the microstructure model may have produced the two simulated pores 804(1)-(2). As can also be seen in FIG. 10, the simulated temperature history of the porosity zone 1002(8) may show that the porosity zone 1002(8) experienced relatively low temperatures during the simulated AM process. Thus, the porosity zone 1002(8) may include a lack-of-fusion area, and in response, the microstructure model may have produced two further simulated pores 804(3)-(4).

In some embodiments, running the microstructure model (step 212) may include generating one or more outputs. An output of the microstructure model may include a simulated grain structure. An output of the microstructure model may include a simulated porosity profile. An output of the microstructure model may include the simulated part. The simulated part output from the microstructure model may include at least a portion of the simulated grain structure or the simulated porosity profile.

One or more embodiments may include generating the performance model (step 208). In some embodiments, the performance model may be called a “fatigue model.” The performance model may include a simulation of applying performance or fatigue testing on the simulated part based on one or more of the inputs. The performance model may predict reliability of the simulated part. For example, the performance model may predict reliability of the simulated part with respect to fatigue damage. The performance model may employ a component life prediction (CLP) framework. Generating the performance model (step 208) may include using the simulated part, the simulated grain structure, or the simulated porosity profile as input. Generating the performance model (step 208) may include using one or more loading parameters of the one or more parameters 106 as input.

In some embodiments, running the performance model (step 214) may include using the generated performance model to determine a simulated performance life of the simulated part. Running the performance model (step 214) may include determining the simulated performance life based on the simulated grain structure of the simulated part or the simulated porosity profile of the simulated part. Running the performance model (step 214) may include determining the simulated performance life based on the residual stress profile of the simulated part, the distortion profile of the simulated part, the surface roughness mapping for the simulated part, or the loading parameters. The simulated performance life may include a value indicating how long the simulated part may last. In one embodiment, the simulated performance life may include a number of cycles. A cycle may include an action that the simulated part performs repeatedly. For example, the simulated part may include a gear, and the cycle may include the gear undergoing one complete rotation. In some embodiments, the simulated performance life may include a time value that may indicate a length of time the simulated part may last. The simulated performance life may include other ways to indicate performance life.

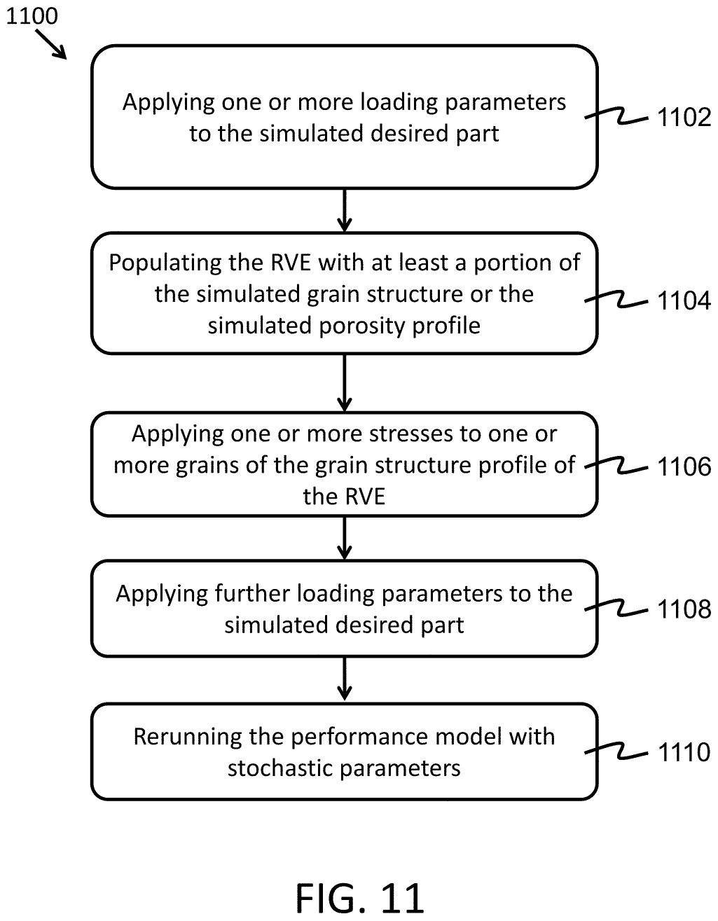

Running the performance model (step 214) may include one or more steps of the method 1100. FIG. 11 depicts one embodiment of the method 1100. In one embodiment, the method 1100 may include applying one or more loading parameters to the simulated part (step 1102). Applying one or more loading parameters to the simulated part (step 1102) may include performing a global FEA of the simulated part under the one or more loading parameters. Applying one or more loading parameters to the simulated part (step 1102) may include identifying one or more areas of interest of the simulated part, extracting boundary conditions of these one or more areas of interest, and selecting a representative volume element (RVE) from the one or more areas of interest. An RVE may include a portion of the simulated part that the system 100 can analyze, and whose analysis may produce a result representative of a larger portion of the simulated part (e.g., the entire simulated part).

The method 1100 may include populating the RVE with at least a portion of the simulated grain structure or the simulated porosity profile of the microstructure model (step 1104). The RVE may simulate one or more high-stress portions of the simulated part (e.g., portions of the simulated part where cracking is more likely to occur). The method 1100 may include applying one or more stresses to one or more grains of the grain structure profile of the RVE (step 1106). The one or more stresses may include stresses from contact surface applications (e.g., stresses that a part may experience in response to contact from a bearing or gear). In some embodiments, applying one or more stresses to one or more grains of the grain structure profile of the RVE (step 1106) may include generating one or more surface traction profiles using a mixed-elastohydrodynamic lubrication (EHL) solver. Applying one or more stresses to one or more grains of the grain structure profile (step 1106) may include performing a FEA on the RVE under the one or more stresses on the one or more grains. Applying one or more stresses to one or more grains of the grain structure profile (step 1106) may include determining the location or time where one or more cracks may form in the microstructure of the RVE.

In one embodiment, running the performance model (step 214) may include simulating the loading parameters on the simulated part in successive loading cycles until a predetermined level of mechanical failure in the simulated part is reached. For example, the method 1100 may include applying further loading parameters to the simulated part (step 1108) (or one or more portions of the simulated part, such as one or more RVEs selected from the areas of interest). Applying further loading parameters to the simulated part (step 1108) may include repeating portions of steps 1102-1106, and may include predicting fatigue damage on a cycle-by-cycle basis. Applying further loading parameters to the simulated part (step 1108) may include simulating the cracks propagating and coalescing in the simulated part. In one embodiment, the number of cycles to crack initiation or propagation may be calculated by employing stress field data at one or more nodal points of the RVE's microstructure. In some embodiments, applying further loading parameters to the simulated part (step 1108) may include employing damage mechanics models that may govern damage accumulation, crack nucleation, and early propagation. Applying further loading parameters to the simulated part (step 1108) may include the cracks reaching the surface of the simulated part, which may indicate the simulated part failing.

In some embodiments, determining the simulated performance life of the simulated part (part of step 214) may include adding up the number of cycles until a predetermined level of mechanical failure is reached. This simulated performance life may include a simulated fatigue life of the simulated part. For example, applying further loading parameters to the simulated part (step 1108) may include calculating the number of cycles performed to initiate a crack in the grain structure of the simulated part. Initiating the crack in the grain structure may include initiating the crack on a grain boundary of the grain structure. In some embodiments, calculating the number of cycles may employ the equation:

$${N}_{i} = \frac{4 G {W}_{G}}{{( Δ τ - 2 M k )}^{2} ( 1 - v ) d}$$

where Nᵢ is the number of cycles, G is the shear modulus, W_{G} is the specific fracture of energy per unit area, Δτ is the average resolved shear stress range, M is the grain orientation factor, k is the frictional stress, v is the Poisson's ratio, and d is the grain size. In some embodiments, the simulated porosity profile may affect the values of W_{G} or k, which may change the life value for different simulated parts that undergo the same stress distribution. In one embodiment, including porosity in the microstructure model may change the internal stress distribution (which may cause local stress concentration), which may also change the number of cycles. In some embodiments, the simulated performance life may include the number of cycles, Nᵢ.

In some embodiments, the method 1100 may include rerunning the performance model (which may include performing steps similar to steps 1102-1108) with stochastic parameters (step 1110). Rerunning the performance model with stochastic parameters (step 1110) may include generating a life distribution for the simulated part. The life distribution may include one or more of the simulated performance life values generated by the performance model as part of steps 1102-1108 of the method 1100 or of the step 214 of the method 200. The life distribution may include an average simulated performance life (e.g., mean, median, or mode), a standard distribution of the simulated performance lives, or another statistical value.

### Surface Roughness

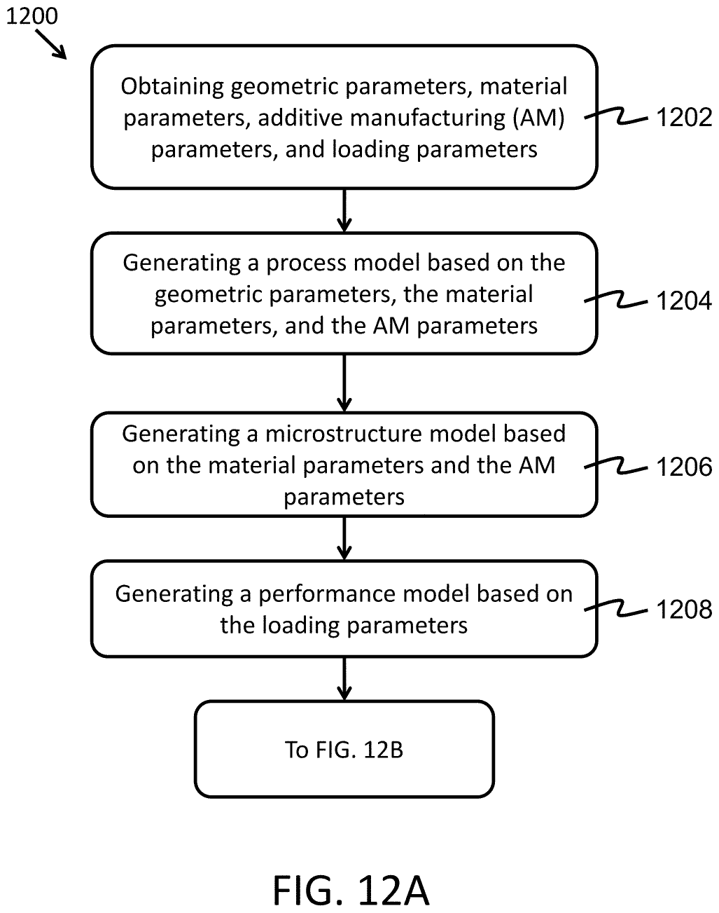

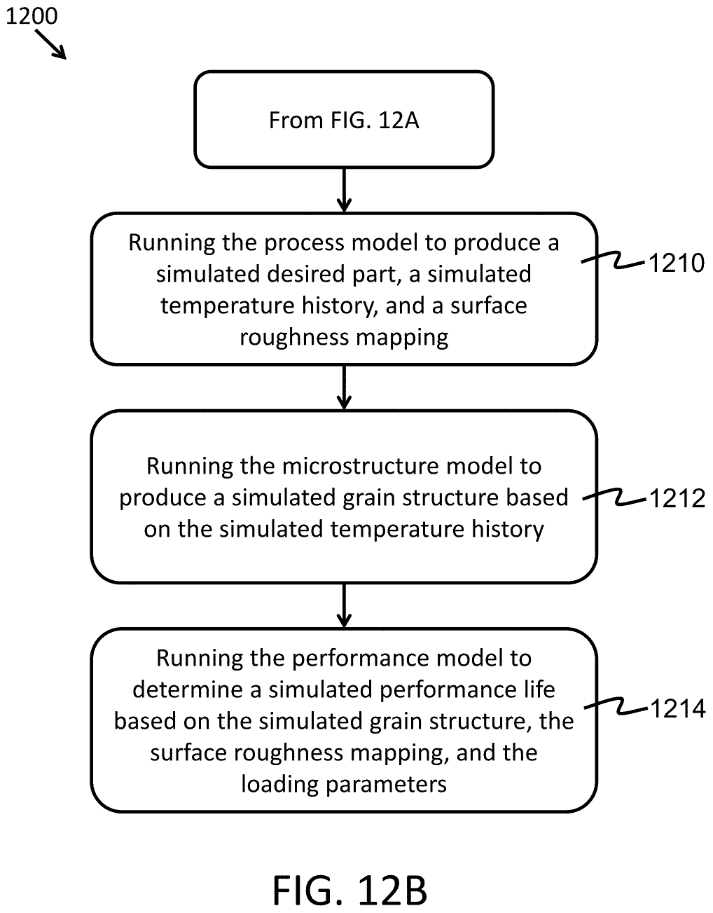

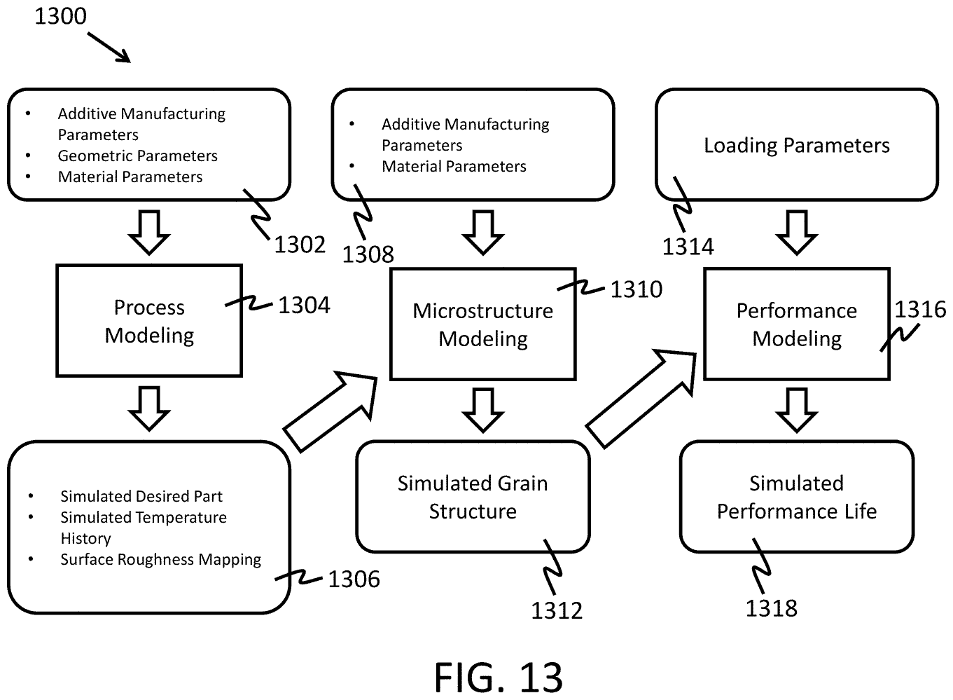

FIG. 12A and FIG. 12B depict one embodiment of a method 1200. The method 1200 may include a method for modeling performance in a part manufactured using an AM process. The method 1200 may include obtaining geometric parameters or material parameters for a part, AM parameters for an AM process, or loading parameters for the part (step 1202). The method 1200 may include generating a process model based on the geometric parameters, the material parameters, or the AM parameters (step 1204). The method 1200 may include generating a microstructure model based on the material parameters or the AM parameters (step 1206). The method 1200 may include generating a performance model based on the loading parameters (step 1208).

The method 1200 may include performing performance simulation. Performing performance simulation may include running the process model to produce a simulated part, a simulated temperature history for the simulated part, or a surface roughness mapping for the simulated part (step 1210). Performing performance simulation may include running the microstructure model to produce a simulated grain structure of the simulated part based on the simulated temperature history (step 1212). Performing performance simulation may include running the performance model to determine a simulated performance life based on the simulated grain structure, the surface roughness mapping for the simulated part, or the loading parameters (step 1214).

In some embodiments, the steps of obtaining geometric parameters or material parameters for a part, AM parameters for an AM process, or loading parameters for the part (step 1202); generating a process model based on the geometric parameters, the material parameters, or the AM parameters (step 1204); generating a microstructure model based on the material parameters or the AM parameters (step 1206); or generating a performance model based on the loading parameters (step 1208) may be similar to the steps of obtaining geometric parameters or material parameters for a part, AM parameters for an AM process, or loading parameters for the part (step 202); generating a process model based on the geometric parameters, the material parameters, or the AM parameters (step 204); generating a microstructure model based on the material parameters or the AM parameters (step 206); generating a performance model based on the loading parameters (step 208) of the method 200 of FIG. 2A and FIG. 2B. In one embodiment, running the process model to produce a simulated part and a simulated temperature history for the simulated part (step 1210) may include similar steps, functionality, or other actions to running the process model of step 210.

In some embodiments, running the process model (step 1210) may include producing a surface roughness mapping. The surface roughness mapping may include a portion of an outer surface area of the simulated part and a surface roughness factor corresponding to that portion of the outer surface area. The simulated part may include an outer surface area. The outer surface area may include a portion of the simulated part that is exposed. In one or more embodiments, the number of simulated points on the outer surface area may be one point, 100 points, 1,000 points, 10,000 points, 100,000 points, 1 million points, 10 million points, a number of points between 1 and 10 million, or a number of points greater than 10 million.

In one embodiment, producing the surface roughness mapping (as part of the step 1210) may include meshing the outer surface area of the simulated part into discrete facets. A discrete facet of the outer surface area may include a delineated portion of the outer surface area. Meshing the outer surface area may include extracting the surface of the simulated part. For example, the system 100 may use a CAD file parser to extract the surface of the selected portion. In some embodiments, the discrete facets may all be equally sized or shaped, while in other embodiments, the discrete facets may include different sizes or shapes. The shapes may include triangles, quadrilaterals, hexagons, or other shapes. The discrete facets may tessellate the outer surface area.

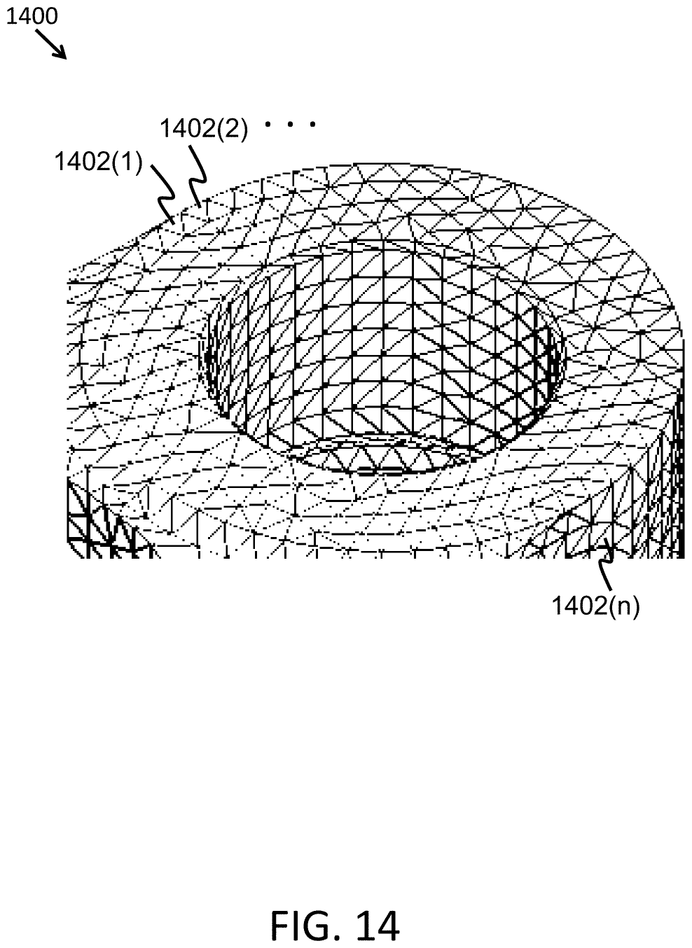

FIG. 14 depicts one embodiment of a portion 1400 of a simulated part that has been meshed into multiple discrete facets. The portion 1400 may include an outer surface area of the simulated part. The portion 1400 may include one or more discrete facets 1402(1)-(n). As shown in FIG. 14, the discrete facets 1402(1)-(n) may include quadrilateral, equally sized discrete facets. The discrete facets 1402(1)-(n) may include discrete facets smaller and differently shaped than other discrete facets.

Producing the surface roughness mapping may include determining a surface roughness factor for each discrete facet 1402. The surface roughness factor may include a measurement of the roughness of the surface of the discrete facet 1402. In some embodiments, the surface roughness factor may be measured in micrometers (μm). The surface roughness factor may be based on a surface angle of the discrete facet 1402 with respect to a reference plane. In some embodiments, the reference plane may include a horizontal plane, a vertical plane, a slanted plane, or some other oriented plane. The surface roughness factor may be based on one or more AM parameters. These AM parameters may include laser power, scanning speed, hatch spacing, melt pool depth, melt pool width, or other AM parameters.

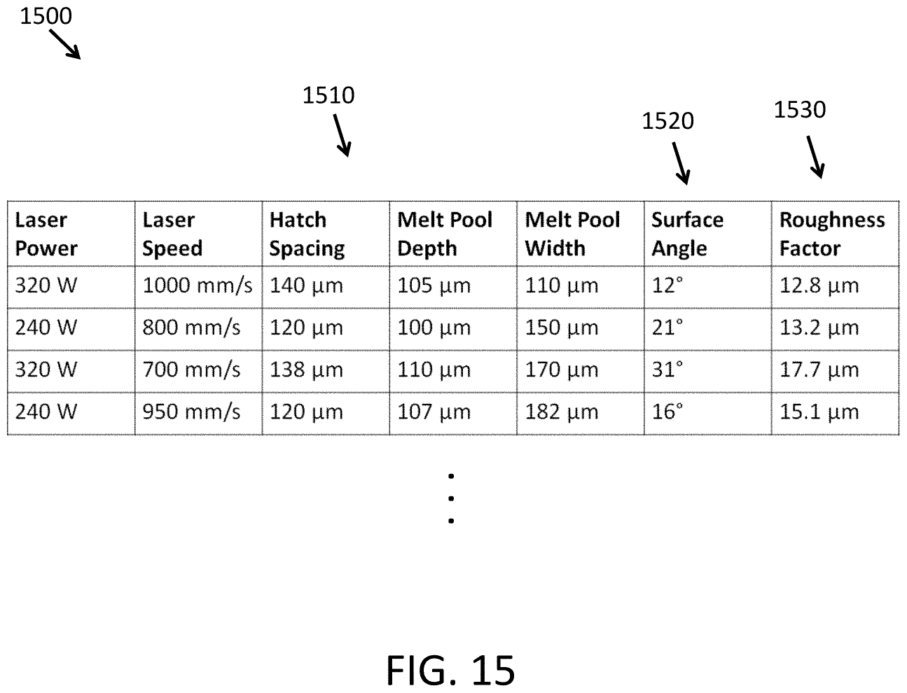

In one embodiment, determining the surface roughness factor for each discrete facet 1402 may include querying the database 112. The database may include one or more combinations of experimental AM parameters, experimental surface angles, and corresponding surface roughness factors. Determining the surface roughness factor may include identifying the surface roughness factor for each discrete facet 1402 associated with the AM parameters and the surface angle. FIG. 15 depicts one embodiment of a portion 1500 of the database 112. The portion 1500 of the database 112 may include a table. The portion 1500 may include data structures, functionality, or other database features similar to those of the portion 900 of FIG. 9. The portion 1500 may include one or more experimental AM parameters 1510. For example, the experimental AM parameters 1510 may include laser power, laser speed, hatch spacing, melt pool depth, or melt pool height. The portion 1500 may include one or more experimental surface angles 1520. The portion 1500 may include one or more corresponding surface roughness factors 1530.

In one embodiment, querying the database 112 may include using a query that includes one or more experimental AM parameters 1520 or experimental surface angles 1530. In some embodiments, querying the database 112 may include returning the corresponding roughness factor 1530. For example, a query may include that the laser power is “240 W,” the laser speed is “800 mm/s,” the hatch spacing is “120 μm,” the melt pool depth is “100 μm,” the melt pool width is “150 μm,” and the surface angle is “21°.” In response to processing the query, the database 112 may return “13.2 μm” as the corresponding surface roughness factor. In some embodiments, the query parameters may match the experimental AM parameters and the experimental surface angle. In one embodiment, the database 112, a DBMS, or some other program may calculate which database record most closely matches the query. The database 112, DBMS, or other program may use a matching method to select the database record. The matching method may include nearest neighbor, optimal pair, optimal full, or some other matching method.

In one embodiment, the microstructure model may include a physics-based model (such as the KGT model) to predict one or more microstructure features, produce the simulated grain structure, determine the surface roughness factor for one or more discrete facets 1402, or produce the surface roughness mapping. In some embodiments, the microstructure model may include a machine learning model to make one or more of the predictions. In another embodiment, the microstructure model may include a combination of a physics-based model and a machine learning model. The machine learning model may be similar to the machine learning model discussed above in relation to predicting porosity of the simulated part. The machine learning model used to determine the determine the surface roughness factor for one or more discrete facets 1402 or produce the surface roughness mapping may be the same model or may be a different model than the machine learning model used to produce the porosity profile, discussed above.

In some embodiments, the machine learning model may receive training data as input. The training data may include one or more one or more parameters 106 or one or more outputs from the process model. For example, each instance of training data may include a laser power, a scanning speed, a hatch spacing, a melt pool depth, a melt pool width, or a surface angle. Each instance of training data may include a corresponding surface roughness factor. The machine learning model may train on the training data. The machine learning model may then receive AM parameters and a surface angle from the process model and determine the surface roughness factor for a discrete facet 1402 or produce the surface roughness mapping.

In some embodiments, each discrete facet 1402 may include an upward-facing facet or a downward-facing facet. An upward-facing facet may include a discrete facet 1402 on a portion of the simulated part that is higher in the build direction. A downward-facing facet may include a discrete facet 1402 on a portion of the simulated part that is lower in the build direction. For example, returning to FIG. 4, the outer surface area of the top layer 402 may include an upward-facing facet. If the previous layer 404(2) is the bottom layer, an outer surface of that previous layer 404(2) may include a downward-facing facet.

In one embodiment, producing the surface roughness mapping (as part of the step 1210) for the simulated part may be based on the simulated temperature history. In some embodiments, using a high-powered laser beam on powder material or the part may cause the power or the part to bubble, which may increase the surface roughness. Also in some embodiments, using a low-powered laser beam may result in powder material not sufficiently melting, which may leave unmelted powder and may increase the surface roughness. The running the process model (step 1210) may simulate these phenomena with the simulated powder material, the simulated laser beam 408, or the simulated part, and the simulated temperatures experienced while running the process model (step 1210) may be reflected in the simulated temperature history. In some embodiments, producing the surface roughness mapping (as part of the step 1210) based on the simulated temperature history may include forming at least one simulated melt pool 410 in the simulated part.

In one embodiment, running the microstructure model (step 1212) may include steps, functionality, or actions similar to those of running the microstructure model (step 212 of the method 200). In some embodiments, the microstructure model may include a simulation of microstructural features of the simulated part. The microstructure model may predict one or more microstructure features of the simulated part. The microstructural features may include grain structure, grain texture, grain morphology, grain size, porosity, melt pool properties, microstructural inhomogeneities, surface roughness, or other features. In some embodiments, determining one or more surface roughness factors of one or more discrete facets 1402 or producing the surface roughness profile may occur during the step of generating the microstructure model (step 1206) or during the step of running the microstructure model (step 1212).

In one or more embodiments, running the microstructure model (step 1212) may include generating a surface roughness for the simulated part. Generating the surface roughness may be based on the surface roughness mapping. Generating the surface roughness may include selecting a portion of the simulated part. The portion may include a discrete facet 1402 of the simulated part or may include some other portion of the simulated part. The portion of the simulated part may include a surface roughness factor as indicated by the surface roughness mapping.

Generating the surface roughness for the selected portion may include generating a plurality of points based on the surface roughness factor of the portion. The plurality of points may include an x-value and a y-value. The plurality of points may be randomly generated such that they conform to the equation:

$$R a = \frac{{\sum }_{k = 0}^{k = N} \vert {y}_{k} \vert}{N + 1}$$

where Ra is the surface roughness factor for the portion, k is a number between 0 and N, inclusive, N is the number of points in the plurality of points, and yₖ is the y-value of point k. In some embodiments, the points of the plurality of points may be equally spaced along the x-axis. In other embodiments, the points of the plurality of points may be spaced along the x-axis according to some other measurement (e.g., randomly). As an example, generating the plurality of points may include generating the points (0, 0), (1, 1.2), (2, 3.1), (3, −0.5), and (4, 0.8) where the surface roughness factor (Ra) is 1.12.

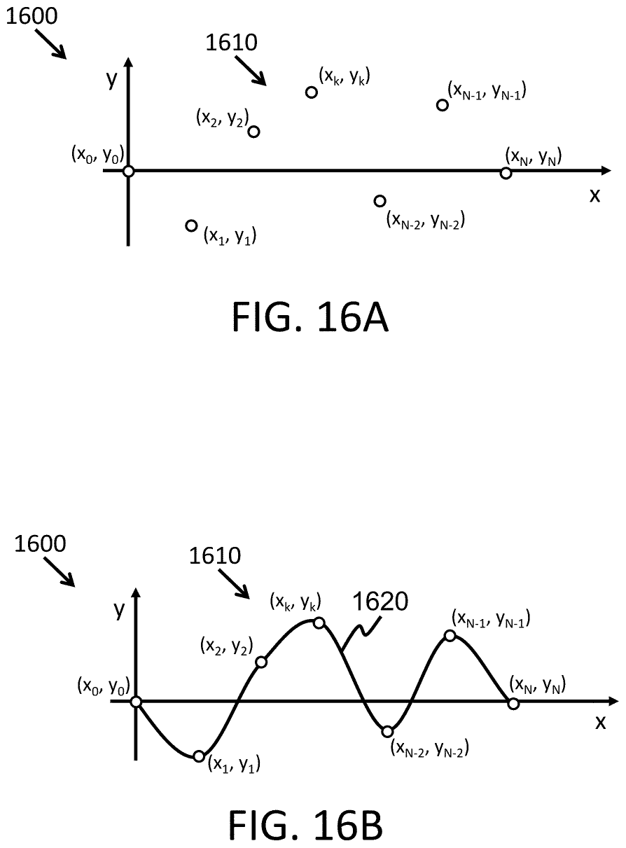

FIG. 16A depicts one embodiment of a graph 1600. The graph 1600 may include a plurality of points 1610. As can be seen in FIG. 16A, generating the plurality of points 1610 may include generating the plurality of points 1610 (x₀, y₀), (x₁, y₁), (x₂, y₂), (xₖ, yₖ), (x_{N-2}, y_{N-2}), (x_{N-1}, y_{N-1}), and (x_{N}, y_{N}). As can also be seen in FIG. 16A, the plurality of points 1610 may be equally spaced in the X direction. The y-values of each of the points can be positive, negative, or zero. While the point (x₀, y₀) is (0, 0) in FIG. 16A, this is only an example, and the y-value of point (x₀, y₀) may be some other value.

Generating the surface roughness for the selected portion may include generating a surface profile function. The surface profile function may include a function fitted to the plurality of points 1610. FIG. 16B depicts one example of the graph 1600. The graph 1600 may a function 1620 fitted to the plurality of points 1610.

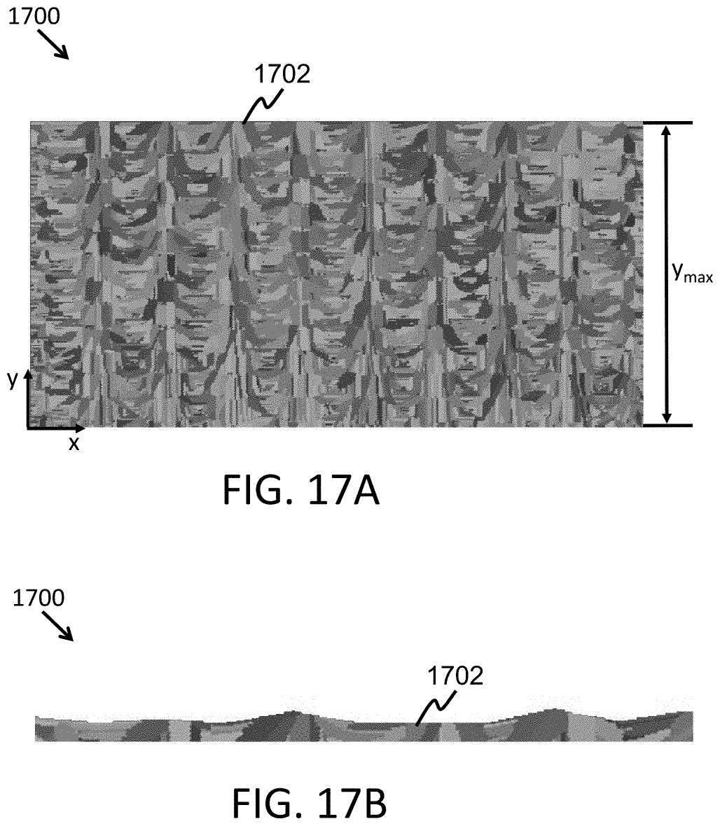

Generating the surface roughness for the selected portion may include adjusting the surface roughness of the selected portion. Before adjusting the surface roughness of the selected portion, the outer surface of the selected portion may include no surface roughness (i.e., the outer surface may be flat). FIG. 17A depicts one example of a selected portion 1700. The selected portion 1700 may include an outer surface 1702. The outer surface may include no surface roughness. Thus, each point of the outer surface 1702 may include the coordinate (xₖ, yₘₐₓ) where yₘₐₓ is the highest y-value. Since the outer surface 1702 is a flat surface, each point of the outer surface includes the same y-value.

In some embodiments, adjusting the surface roughness of the selected portion 1700 may include adjusting the y-value of each point of the portion 1700 according to the equation Δy=f(x)*y/yₘₐₓ where Δy is the amount by which the y-value of the point is changed, f(x) is the y-value of the surface profile function 1620 at the value of x, y is y-value of the point, and yₘₐₓ is the highest y-value. FIG. 17B depicts one embodiment of the selected portion 1702 after adjusting the surface roughness. As can be seen from FIG. 17B, the outer surface 1702 is no longer flat and has been adjusted as discussed above.

In some embodiments, running the performance model (step 1214) may include using the generated performance model to determine a simulated performance life of the simulated part. The simulated part may include the simulated grain structure and the surface roughness mapping. The performance model may include a simulation of applying performance or fatigue testing on the simulated part based on one or more of the inputs. The performance model may predict reliability of the simulated part.

In one embodiment, running the performance model (step 1214) may include determining the simulated performance life based on one or more of the simulated grain structure of the simulated part, the surface roughness mapping of the simulated part, the loading parameters, one or more microstructural defects of the simulated part, the residual stress profile, or other data. A microstructural defect may include porosity, unmelted particles, grain anisotropy, balling effects, material inhomogeneity, residual stress, distortion, inclusion, or other defects. In one embodiment, running the performance model (step 1214) may include determining the simulated performance life based the simulated grain structure of the simulated part, the surface roughness mapping of the simulated part, or the loading parameters. In some embodiments, running the performance model (step 1214) may include determining the simulated performance life based on the simulated grain structure for the simulated part, the simulated porosity profile for the simulated part, the surface roughness mapping for the simulated part, and the loading parameters. In one or more embodiments, running the performance model (step 1214) may include determining the simulated performance life based on the simulated grain structure, the surface roughness mapping for the simulated part, the residual stress profile, and the loading parameters.

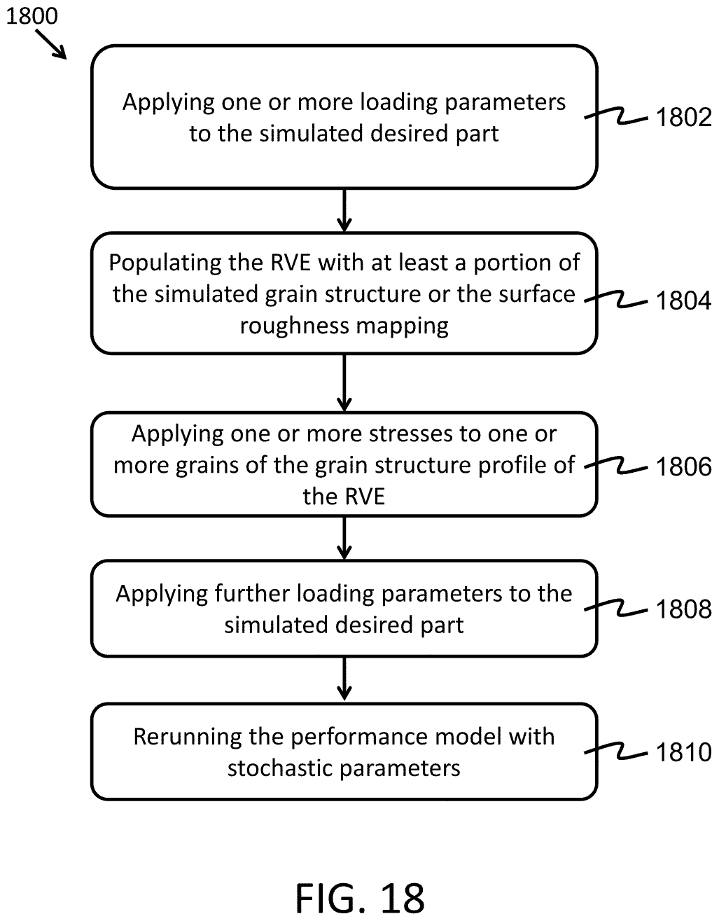

Running the performance model (step 1214) may include one or more steps of the method 1800. FIG. 18 depicts one embodiment of the method 1800. The method 1800 may include steps, functionality, or actions similar to the method 1100 of the FIG. 11. The method 1800 may include applying one or more loading parameters to the simulated part (step 1802). This step may be similar to the step of applying one or more loading parameters to the simulated part (step 1102). The method 1800 may include populating an RVE with at least a portion of the simulated grain structure or the surface roughness mapping (step 1804). This step may be similar to the step of populating the RVE with at least a portion of the simulated grain structure or the simulated porosity profile of the microstructure model (step 1104). Populating an RVE with at least a portion of the simulated grain structure or the surface roughness mapping (step 1804) may include one or more steps, functionality, or actions discussed above in relation generating a surface roughness for the simulated part.

The method 1800 may include applying one or more stresses to one or more grains of the grain structure profile of the RVE (step 1806). The grain structure profile may include surface roughness data such as the surface roughness mapping. Applying the one or more stresses (step 1806) may include functionality similar to applying the one or more stresses (step 1106 of the method 1100), such as applying stresses from contact surface applications (which may behave differently depending on the grain structure of the outer surface 1702 as affected by the surface roughness mapping), generating one or more surface traction profiles (which may also be affected by the surface roughness of the outer surface 1702), performing a FEA on the RVE, or determining the location or time where one or more cracks may form.

In some embodiments, running the performance model (step 1214) may include simulating the loading parameters on the simulated part in successive loading cycles until a predetermined level of mechanical failure in the simulated part is reached. For example, the method 1800 may include applying further loading parameters to the simulated part (or one or more portions of the simulated part, such as one or more RVEs selected from the areas of interest) (step 1808). Applying further loading parameters to the simulated part (step 1808) may include repeating portions of steps 1802-1806, and may include predicting fatigue damage on a cycle-by-cycle basis. Applying further loading parameters to the simulated part (step 1808) may include simulating the cracks propagating and coalescing in the simulated part. In one embodiment, the number of cycles to crack initiation or propagation may be calculated by employing stress field data at one or more nodal points of the RVE's microstructure. In some embodiments, applying further loading parameters to the simulated part (step 1808) may include employing damage mechanics that may govern damage accumulation, crack nucleation, and early propagation. Applying further loading parameters to the simulated part (step 1808) may include the cracks reaching the outer surface 1702 of the simulated part, which may indicate the simulated part failing.

In some embodiments, determining the simulated performance life of the simulated part (part of step 1214) may include adding up the number of cycles until a predetermined level of mechanical failure is reached to determine a simulated fatigue life of the simulated part. For example, applying further loading parameters to the simulated part (step 1808) may include calculating the number of cycles performed to initiate a crack in the grain structure of the simulated part. This may include actions, steps, or functionality similar to that of applying further loading parameters to the simulated part (step 1108 of the method 1100). In some embodiments, the method 1800 may include rerunning the performance model (which may include performing steps similar to steps 1802-1808) with stochastic parameters (step 1810). Rerunning the performance model with stochastic parameters (step 1810) may include generating a life distribution for the simulated part. The life distribution may include one or more of the simulated performance life values generated by the performance model as part of steps 1802-1808 of the method 1800 or of the step 1214 of the method 1200. The life distribution may include an average simulated performance life (e.g., mean, median, or mode), a standard distribution of the simulated performance lives, or another statistical value.

While discussion in this disclosure may discuss using only a portion of the simulated part for certain steps, it should be noted that such discussed action may apply to the entire simulated part, or vice versa. For example, in one embodiment, one or more outputs of the one or more models (e.g., the simulated temperature history, the surface roughness mapping, the residual stress profile, the distortion profile, the simulated grain structure, the simulated porosity profile, or the simulated performance life) may correspond to the entire simulated part. In some embodiments, an output may correspond to a portion of the simulated part. In one embodiment, one or more inputs to the one or more models may correspond to the entire simulated part or may correspond to only a portion of the simulated part. In some embodiments, a model may generate, process, or act upon the entire simulated part or only a portion of the simulated part. A portion of the simulated part may include a RVE. The RVE may include a generic RVE. The RVE may include a geometry-dependent RVE.

The systems and methods discussed herein improve the technology and technical field of additive manufacturing. The systems and methods discussed herein are able to address porosity issues, surface roughness issues, residual stress issues, distortion issues, and other issues during the design phase of manufacturing a part instead of after the part has been physically manufactured. By addressing these issues and making adjustments to the part during the design phase, physically manufacturing parts in order to test for these issues may no longer be necessary, which saves manufacturing time and costs associated with manufacturing the part. Specifically, generating the microstructure model (e.g., as part of step 206 of the method 200 or the step 1206 of the method 1200) and running the microstructure model (e.g., as part of step 212 of the method 200 or the step 1212 of the method 1200) can simulate the microstructural features of the part, such as porosity, surface roughness, or other microstructural features and allow the system 100 to test these features while running the performance model (step 214 or step 1214). Thus, the system 100 can test simulated parts with different microstructural features instead of physically manufacturing multiple different parts, each with different microstructural features, which includes high manufacturing costs and takes a long amount of time to manufacture and test.

The systems and methods disclosed herein improve AM-produced parts in tribological applications (i.e., applications including wear, friction, and interacting surfaces in relative motion). In tribological applications, product performance is based on near-surface mechanical properties and surface finishes of components. The systems and methods disclosed herein improve AM-produced parts in cellular applications. Engineered scaffolding for cell cultures has become a promising area of research in tissue engineering. Scaffolds often closely mimic the natural architecture and porosity of an extracellular matrix to promote proper integration and functioning with human cells.

Furthermore, the models used in the systems and methods discussed herein (e.g., the process model, the microstructure model, or the performance model) are complex models that each include multiple portions that are processed and tested. As discussed above, the number of simulated points on the simulated part where measurements are taken or where processing may adjust the microstructure may include a large number of points, including 10,000 points, 100,000 points, 1 million points, 10 million points, or a number of points greater than 10 million. Furthermore, some models (e.g., the microstructure model) may include one or more machine learning models that may train on multiple pieces of training data. The complexity of these models allow for more accurate predictions and simulations of the AM process and the simulated part.

Additionally, the components and steps of systems and methods discussed herein are not conventional nor well-known. As discussed previously, software simulation of AM processes have been limited to thermo-mechanical analysis to predict part-level distortion. Thus, conventional, well-known software does not simulate microstructural features of AM-produced parts, and thus, these features are not performance tested. In contrast, the components and steps of systems and methods discussed herein do simulate microstructure features of AM parts.

Thus, although there have been described particular embodiments of the present disclosure of a new and useful systems and methods for modeling performance in a part manufactured using an additive manufacturing process, it is not intended that such references be construed as limitations upon the scope of this disclosure.

What is claimed:

1. A method of modeling performance in a part manufactured using an additive manufacturing process, the method comprising:
obtaining geometric parameters and material parameters for the part, additive manufacturing parameters for the additive manufacturing process, and loading parameters for the part;
generating a process model based on the geometric parameters, the material parameters, and the additive manufacturing parameters;
generating a microstructure model based on the material parameters and the additive manufacturing parameters;
generating a performance model based on the loading parameters; and
performing performance simulation by:
running the process model to produce a simulated part, a simulated temperature history for the simulated part, and a surface roughness mapping for the simulated part;
running the microstructure model to produce a simulated grain structure of the simulated part based on the simulated temperature history; and
running the performance model to determine a simulated performance life based on the simulated grain structure, the surface roughness mapping for the simulated part, and the loading parameters.

2. The method of claim 1, wherein the additive manufacturing parameters include at least one of:
laser power parameters;
laser scanning speed parameters; or
laser beam shape and size.

3. The method of claim 1, wherein the additive manufacturing parameters include at least one of:
powder layer thickness;
hatch spacing parameters;
pre-heat temperature; or
scan rotation parameters.

4. The method of claim 1, wherein the geometric parameters include three-dimensional computer-aided design files of the part.

5. The method of claim 1, wherein:
the simulated part has an outer surface area; and
producing the surface roughness mapping includes meshing the outer surface area of the simulated part into discrete facets and determining a surface roughness factor for each discrete facet.

6. The method of claim 5, wherein the surface roughness factor for each discrete facet is based on a surface angle of the discrete facet with respect to a reference plane and the additive manufacturing parameters.

7. The method of claim 6, further comprising determining the surface roughness factor for each discrete facet by:
querying a database with combinations of experimental additive manufacturing parameters, experimental surface angles, and corresponding surface roughness factors; and
identifying the surface roughness factor for each discrete facet associated with the additive manufacturing parameters and the surface angle.

8. The method of claim 5, wherein each discrete facet comprises at least one of an upward facing facet or a downward facing facet.

9. The method of claim 1, wherein producing the surface roughness mapping for the simulated part is based on the simulated temperature history.

10. The method of claim 9, wherein producing the surface roughness mapping based on the simulated temperature history includes forming at least one simulated melt pool in the simulated part.

11. The method of claim 1, wherein:
running the microstructure model further comprises producing a simulated porosity profile for the simulated grain structure; and
running the performance model further comprises determining a simulated performance life based on the simulated grain structure, the simulated porosity profile, the surface roughness mapping for the simulated part, and the loading parameters.

12. The method of claim 1, wherein:
running the process model further comprises producing a residual stress profile within the simulated part; and
running the performance model further comprises determining the simulated performance life based on the simulated grain structure, the surface roughness mapping for the simulated part, the residual stress profile, and the loading parameters.

13. The method of claim 1, wherein running the process model includes simulating the formation of the simulated part by adding sequential layers of material on top of one another according to the additive manufacturing parameters.

14. The method of claim 1, wherein running the performance model includes simulating the loading parameters on the simulated part in successive loading cycles until a predetermined level of mechanical failure in the simulated part is reached, wherein the simulated part includes the simulated grain structure and the surface roughness mapping.

15. The method of claim 14, wherein the simulated part further includes a residual stress profile and a distortion profile.

16. The method of claim 14, wherein determining the simulated performance life of the simulated part comprises adding up the number of cycles until the predetermined level of mechanical failure is reached to determine a simulated fatigue life of the simulated part.

17. A method of modeling performance in a part manufactured using an additive manufacturing process, the method comprising:
configuring a computer-based system to predict fatigue life in the part, the computer-based system comprising:
an input device operable to receive geometric parameters and material parameters for the part, additive manufacturing parameters for the additive manufacturing process, and loading parameters for the part;
an output device operable to convey simulated fatigue life information relating to the part;
memory operable to store the geometric parameters, material parameters, the additive manufacturing parameters, the loading parameters, and computer-executable instructions including performance prediction processes; and
a processor;
predicting performance life in the part with the computer-based system according to the performance prediction processes of the computer-executable instructions, wherein the computer-executable instructions cause the processor to predict performance life in the part by:
generating a process model based on the geometric parameters, the material parameters, and the additive manufacturing parameters;
generating a microstructure model based on the material parameters and the additive manufacturing parameters;
generating a performance model based on the loading parameters; and
performing performance simulation by:
running the process model to produce a simulated part, a simulated temperature history for the simulated part, and a surface roughness mapping for the simulated part;
running the microstructure model to produce a simulated grain structure of the simulated part based on the simulated temperature history; and
running the performance model to determine a simulated performance life based on the simulated grain structure, the surface roughness mapping for the simulated part and the loading parameters.

18. The method of claim 17, wherein the simulated part has an outer surface area and computer executable instructions are operable to produce the surface roughness mapping by meshing the outer surface area of the simulated part into discrete facets and determining a surface roughness factor for each discrete facet.

19. The method of claim 18, wherein the surface roughness factor for each discrete facet is determined based on a surface angle of the discrete facet with respect to a reference plane and the additive manufacturing parameters.

20. The method of claim 19, wherein:
the memory further comprises a database with combinations of experimental additive manufacturing parameters, experimental surface angles, and corresponding surface roughness factors; and
producing the surface roughness mapping further comprises querying the database and identifying the surface roughness factor for each discrete facet associated with the additive manufacturing parameters and the surface angle.

21. A method of modeling performance in a part manufactured using an additive manufacturing process, the method comprising:
obtaining geometric parameters and material parameters for the part, additive manufacturing parameters for the additive manufacturing process, and loading parameters for the part;
generating a process model based on the geometric parameters, the material parameters, and the additive manufacturing parameters;
generating a microstructure model based on the material parameters and the additive manufacturing parameters;
generating a performance model based on the loading parameters; and
performing performance simulation by:
running the process model to produce a simulated part, a simulated temperature history for the simulated part, and a surface roughness mapping for the simulated part, wherein the simulated part has an outer surface area and the surface roughness mapping is produced by meshing the outer surface area of the simulated part into discrete facets and running the process determining a surface roughness factor for each discrete facet;
running the microstructure model to produce a simulated grain structure of the simulated part based on the simulated temperature history; and
running the performance model to determine a simulated performance life based on the simulated grain structure, the surface roughness mapping for the simulated part, and the loading parameters.
